(19) United States
(12) Patent Application Publication
(10) Pub. No.: US 2018/0180216 A1
(43) Pub. Date: Jun. 28, 2018

(54) LARGE MICRO-CRYSTALLIZED GLASS-LINED PIPELINE AND MANUFACTURING METHOD THEREOF

(71) Applicant: Wenhua ZHU, Shanghai (CN)

(72) Inventor: Wenhua ZHU, Shanghai (CN)

(21) Appl. No.: 15/108,038

(22) PCT Filed: Jan. 8, 2016
(86) PCT No.: PCT/CN2016/070511

§ 371 Date: Jan. 24, 2018

(30) Foreign Application Priority Data
Sep. 16, 2015 (CN) 2015105872612

(51) Int. Cl. F16L 58/14; F27B 9/28; F27D 11/02; F27B 9/06

(52) U.S. Cl. CPC F16L 58/14; F27B 9/28; F27B 2009/3607; F27B 9/063; F27D 11/02

(57) ABSTRACT

A pipeline has two groups of reinforcing circular ring bodies welded on large flanges at two ends of the pipeline, reinforcing rebar plates and integral reinforcing steel circular pipe fittings are combined and welded symmetrically. Microcrystalline glass lining has level-8 Mohs hardness. By adopting an openable and closeable extra-long horizontal electric heating furnace provided by the present invention and an intelligent temperature control instrument in combination with a new heating-while-rotating process, the extra-large and extra-long integral large micro-crystallized glass-lined pipeline which is high in glass lining layer quality, smooth in circulation, durable, non-corrosive, wear-resistant, high in seismic performance and safe in operation is developed. Various existing pipelines will be inevitably and comprehensively replaced due to comprehensive extra-strong advantages.

### BACKGROUND OF THE PRESENT INVENTION

### Field of Invention

The present invention relates to a pipeline for transporting mediums such as petroleum, natural gas, chemical mediums and coal particles and a manufacturing method thereof, and the pipeline is a long special large micro-crystallized glass-lined oil and gas transportation pipeline which has the advantages that the integral pipeline metal layers and glass lining layers are firmly combined, the corrosive resistance is strong, the wear resistance is strong, the surface is smooth, the integral pipeline structure member is non-deformable, the seismic resistance and mechanical performance is strong and the pipeline is guaranteed to be durable, anticorrosive, smooth in circulation and safe in operation.

### Description of Related Arts

Petroleum and natural gas pipelines are called as oil and gas pipelines for short, are important parts of national public security in China, take an extremely important strategic place in national economy and are called as national major lifelines. As reported, at present China has long-distance oil and gas transporting pipelines with length of about 10⁵ km, gathering and transportation pipelines with length of about 3*10⁵ km, a peak period of pipeline construction will occur in recent years in China, and up to the end of “12th Five-Year Plan”, the total length of oil and gas long-distance transportation pipelines in China will reach 1.5*10⁵ km.

Corrosion is one of key factors which influence the reliability and service life of the petroleum and natural gas pipelines. In recent years, extracted petroleum and natural gas gathering and transportation and long-distance transportation pipelines developed quickly, pH values varied greatly, compositions of transported mediums were complex, the corrosiveness was strong, the wear loss was great and consequently the problem of pipeline corrosion was increasingly outstanding.

In addition, there are technical quality problems related to major safety guarantee such as sudden corrosion and crack accidents of outer walls of pipelines and deformation of integral structures of pipelines due to environmental soil stress.

Leakage occurred in Qingdao oil transportation pipelines and an explosion happened suddenly during repair. Xi Jinping, the Chinese President, gave an important order “Strengthen Safety Production Measures to Firmly Preclude Such Accidents”.

For pipelines made by adopting the existing corrosion inhibitor technique, the inner coating technique and the composite pipeline technique, in fact, materials are attached onto inner wall surfaces of the pipelines. During long-term transportation of oil and gas pipelines, for a reason that oil and gas mediums are scaled on the wall surfaces of the pipelines, periodic flushing and cleaning needs to be performed, oil and gas are greatly wasted, the transportation efficiency is low, the corrosion resistance and wear resistance are poor, the mechanical strength is low, safety problems such as corrosion, crack and deformation of integral structures of the pipelines due to environment stress exist, and consequently the long-distance oil and gas medium transportation pipelines are far from satisfying the requirements.

In 1990, the most authoritative department in the nation set up the project of research on glass-lined pipelines for long-distance transportation of coal particles from coal mines directly to power plants, vertical electric heating furnaces and horizontal electric heating furnaces were elaborately designed and manufactured and automatic temperature control devices are correspondingly equipped.

The vertical electric heating furnaces are not limited by large diameter and ultra-large length of pipelines, and the collimation of the pipelines is guaranteed after the pipelines are sintered. However, glass lining layers on the inner walls of the pipelines are in a flowing state during sintering at high temperature (850-900° C.), consequently upper ends are thin, lower are thicker and the uniformity of the lining layers is poor.

For the horizontal electric heating furnaces, it is difficult to put in and take out the pipelines. Since pipeline supporting sintering racks are flame barriers in the heating furnaces, the integral glass lining layers are not uniformly heated such that the quality of the sintered glass lining layers is poor; during repetitive long-time high-temperature heating of the pipelines, the pipelines and the flange surfaces at the two ends thereof are deformed greatly, the safety and economic benefit of the general installation engineering are directly influenced and parameters are not in compliance with the current national standard GB25025-2010 (equipment diameter ≥1000 mm, difference between maximum diameter and minimum diameter ≤6 mm and flatness tolerance ≤2 mm); in addition, the diameter of the horizontal electric heating furnaces needs to be enlarged and the power consumption is increased; the electric furnaces are easily damaged, etc.

Accordingly, it can be seen that, when the vertical and horizontal electric heating furnaces are used, since the heating temperature of the integral long pipelines is not uniform, it is extremely difficult to break through the bottleneck in the manufacturing of the pipelines, the serious quality problem existing in the integral glass lining layers and the deformation of the integral pipeline structure and the flange surfaces at the two ends thereof.

After more than one year of trial, they are not suitable for long-term pipeline transporting of coal particle, thus research of the project is terminated. In more than years, there is still no developing and manufacturing of large glass lined piping.

Supposing that a project has total length of 2000 km and length of each pipeline is 5 m, the number of installation and connection points is 400 thousand. If the length of each pipeline is 25 m, the number of the installation and connection points can be reduced to 80 thousand.

Supposing that a project has total length of 2,000 km and effective area of pipeline glass lining reaches 6 million m², by calculating according to the requirements that effective area of glass lining layers is greater than or equal to 89 m2 and the number of repaired pinhole is 7 as prescribed in the national standard GB25025-2010 Technical Conditions for Glass Lined Equipment, the number of pinholes in the pipelines of the entire line highly reaches 460 thousand. Certainly, the existence of each pinhole defect will directly influence the safety operation and economic benefit of the oversize project in which totally dozens of billion Yuan have been invested.

These are main reasons why pipelines applicable to petroleum transportation must be large long pipelines and the quality of the integral glass lining layers must be excellent.

Therefore, the innovation of the electric heating furnaces and the reformation of manufacturing techniques and processes must comprehensively satisfy the requirements on the manufacturing of large micro-crystallized glass-lined pipelines with different specifications and excellent integral quality according to the needs of pipeline project lines and maximum length of steel pipe products (diameter is larger than 1 m and two steel pipes can be welded to form a pipeline with length of 25 m), so as to reduce the installation connection points between the trunk pipelines of the entire line, facilitate site construction and installation and greatly improve the overall quality, the circulation effect and the safety operation of the pipeline project.

### SUMMARY OF THE PRESENT INVENTION

The purpose of the present invention is to develop a large micro-crystallized glass-lined pipeline and a manufacturing method thereof.

Wire-mesh-shaped firm adherence layers are formed between inferences of metal and glass lining prime coat of the large micro-crystallized glass-lined pipeline, the micro-crystallized glass lining has excellent physiochemical performance, the formulas and proportions of microcrystalline and amorphous glass lining can be adopted and adjusted according to specific demands of different oil and gas mediums such as acid resistance, alkali resistance, sudden temperature difference change resistance, wear resistance reinforcement and prevention of sudden corrosion accidents and integral pipeline structure deformation due to environmental soil stress, the advanced controlled sintering “core technique” process and micro-crystallization treatment of glass lining can be combined, and the highest technique quality index corresponding to each physiochemical performance demand can be adopted, adjusted, formulated and provided for each oil and gas pipeline project line, especially different structural parts of the same pipeline, so as to comprehensively improve, reinforce and guarantee the durability, anticorrosion, smooth circulation and safety operation of the pipelines of the entire line.

The large micro-crystallized glass-lined pipeline can be laid according to the demand of the current oil and gas pipeline laying project and the maximum length of the manufactured steel pipe or two steel pipes (diameter: 1.0 m-1.6 m) are welded and combined to form an oil and gas pipeline with length of 25 m, so as to reduce installation connection points between the long-distance pipelines of the entire line.

In a first aspect, the present invention provides a large micro-crystallized glass-lined pipeline, comprising a straight cylindrical pipe body, large flanges and reinforcing circular ring bodies, wherein two ends of the straight cylindrical pipe body are flanged to form the large flanges, the reinforcing circular ring bodies are in close fit with a circumference of an outer side of the straight cylindrical pipe body and are welded on inner sides of the large flanges, and micro-crystallized glass lining layers are coated and sintered on an inner wall and an outer wall of the straight cylindrical pipe body, outer sides of the large flanges and outer sides of the reinforcing circular ring bodies.

Further, circumferentially welded girth welding joints are formed between the reinforcing circular ring bodies and the circumference of the outer side of the straight cylindrical pipe body, and circumferentially welded girth welding joints are formed between the reinforcing circular ring bodies and the large flanges.

Further, the large micro-crystallized glass-lined pipeline further comprises reinforcing rebar plates, the reinforcing rebar plates are symmetrically distributed along the circumference of the outer side of the straight cylindrical pipe body, the reinforcing rebar plates are welded on the circumference of the outer side of the straight cylindrical pipe body and are welded with the reinforcing circular ring bodies, and micro-crystallized glass lining layers are coated and sintered on outer sides of the reinforcing rebar plates. A number of the reinforcing rebar plates can be 9-21 groups.

Further, the large micro-crystallized glass-lined pipeline further comprises reinforcing steel circular pipe fittings, the reinforcing steel circular pipe fittings are symmetrically distributed along the circumference of the outer side of the straight cylindrical pipe body and are arranged between two groups of reinforcing rebar plates, two ends of the reinforcing steel circular pipe fittings are respectively welded with the outer wall of the straight cylindrical pipe body and the reinforcing circular ring bodies, and micro-crystallized glass lining layers are coated and sintered on outer sides of the reinforcing steel circular pipe fittings. A number of the reinforcing steel circular pipe fittings can be 3-6.

Further, the micro-crystallized glass lining layers of the large micro-crystallized glass-lined pipeline are prepared by adopting a manufacturing method through an openable and closeable extra-long horizontal electric heating furnace combined with an intelligent temperature program control/adjustment/recording instrument device, the intelligent temperature program control/adjustment/recording instrument device has a temperature control accuracy of ±1° C. and is combined with the openable and closeable extra-long horizontal electric heating furnace, and a heating-while-rotating sintering process is implemented in a combined manner.

Further, the openable and closeable extra-long horizontal electric heating furnace comprises a group of fixed horizontal bottom electric heating furnace in a shape of a semicircular ring body, two groups of openable and closeable horizontal electric heating furnaces in a shape of a ¼ circular ring body and two groups of circular plane electric heating furnaces; the two groups of openable and closeable horizontal electric heating furnaces in the shape of the ¼ circular ring body are arranged at an upper portion of the fixed horizontal bottom electric heating furnace in the shape of the semicircular ring body, and in a closed state, the two groups of openable and closeable horizontal electric heating furnaces in the shape of the ¼ circular ring body and the fixed horizontal bottom electric heating furnace in the shape of the semicircular ring body form a circular ring body; and the two groups of circular plane electric heating furnaces are arranged at two ends of the internal portion of the fixed horizontal bottom electric heating furnace in the shape of the semicircular ring body and the two groups of openable and closeable horizontal electric heating furnaces in the shape of the ¼ circular ring body.

Further, an integral circular ring body horizontal electric heating furnace formed by the fixed horizontal bottom electric heating furnace in the shape of the semicircular ring body and the two groups of openable and closeable horizontal electric heating furnaces in the shape of the ¼ circular ring body corresponds to sintering of the glass lining layers on the inner wall and the outer wall of the straight cylindrical pipe body and integral outer structural assemblies of the large micro-crystallized glass-lined pipeline, and the two groups of circular plane electric heating furnaces correspond to sintering of the glass lining layers on the faces of the large flanges at the two ends of the pipeline. The integral structure of the openable and closeable extra-long horizontal electric heating furnace is substantially consistent with the structure of the pipeline. The integral outer structural assemblies refer to pipeline components outside the straight cylindrical pipe body, e.g., the reinforcing circular ring bodies, the reinforcing rebar plates and the reinforcing steel circular pipe fittings.

The micro-crystallized glass lining layer on the inner wall of the straight cylindrical pipe body, the micro-crystallized glass lining layers on the outer wall of the straight cylindrical pipe body and the integral outer structural assemblies and the micro-crystallized glass lining layers on the faces of the large flanges at the two ends of the pipeline are different in compositions.

According to the large micro-crystallized glass-lined pipeline provided by the present invention, by using the irreplaceable excellent physiochemical performance of the glass lining in combination with the advantage of above-level-8 Mohs hardness of the microcrystalline glass lining, different formulas and proportions of microcrystalline and amorphous glass lining and different sintering temperature of the micro-crystallized glass lining layers can be adopted and adjusted for each oil and gas transportation pipeline project and according to specific demands of different physiochemical performance of different structural parts of the same pipeline. Micro-crystallized glass lining layers mainly consisting of microcrystalline glass lining capable of reinforcing seismic and mechanical strength are adopted on the outer wall of the straight cylindrical pipe body and the integral outer structural assemblies of the pipeline; a micro-crystallized glass lining layer mainly consisting of microcrystalline glass lining capable of reinforcing mechanical strength is adopted on the deep layers of the inner wall of the straight cylindrical pipe body of the pipeline, and a micro-crystallized glass lining layer mainly consisting of amorphous glass lining capable of resisting corrosion and forming smooth surfaces is adopted on the surface layers of the inner wall of the straight cylindrical pipe body of the pipeline; and micro-crystallized glass lining layers mainly consisting of microcrystalline glass lining capable of greatly reinforcing mechanical strength are adopted on the faces of the large flanges at the two ends of the pipeline, so as to avoid the situation that the glass lining layers on the faces of the large flanges are cracked due to great force for tightening bolts, comprehensively improve and guarantee the durability, anticorrosion, wear resistance, smooth circulation and safety operation of the large micro-crystallized glass-lined oil and gas pipelines of the entire line and innovatively manufacture the large micro-crystallized glass-lined pipeline mainly consisting of microcrystalline glass lining.

In a second aspect, the present invention provides a manufacturing method of a large micro-crystallized glass-lined pipeline and aims at innovatively developing an openable and closeable extra-long horizontal electric heating furnace combined with an intelligent temperature program control/adjustment/recording instrument device, the integral structure of the electric furnace is similar to the structure of the large micro-crystallized glass-lined pipeline, an integral circular ring body horizontal electric heating furnace corresponds to sintering of the micro-crystallized glass lining layers on the inner wall and the outer wall of the straight cylindrical pipe body and integral outer structural assemblies of the pipeline, two groups of circular plane electric heating furnaces correspond to sintering of the micro-crystallized glass lining layers on the faces of the large flanges at the two ends of the pipeline, corresponding fixed temperature differences between furnace body temperature measured by thermocouples on a furnace wall and heating temperature of the glass lining layers on the inner wall of the pipe and the faces of the large flanges at the two ends of the pipeline are searched and positioned by intelligent temperature control devices, the new heating-while-rotating sintering process during the sintering of the glass lining layers of the pipe is implemented in a combined manner, different sintering temperature of the micro-crystallized glass lining with different compositions of the integral micro-crystallized glass lining layers on the straight cylindrical pipe body of the pipeline and the faces of the large flanges at the two ends of the pipeline is precisely controlled by the intelligent temperature control devices capable of respectively and independently controlling heating power, synchronous integral sintering is effectively implemented and thereby the large micro-crystallized glass-lined pipeline with integral quality which is obviously superior to the quality as prescribed in the current national standard GB25025-2010 is manufactured.

The manufacturing method of the large micro-crystallized glass-lined pipeline provided by the present invention specifically comprises the following steps:

1) manufacturing pipeline components: respectively manufacturing a straight cylindrical pipe body and large flanges formed by flanging two ends of the straight cylindrical pipe body;

pipelines are connected through girth welding joints, X-ray flaw detection is performed to the girth welding joints according to JB/T4730 to obtain pipe components which are in compliance with supervision regulations on safety technology of pressure vessels, and thickness of steel plates of the pipeline components shall be in compliance with pipeline pressure vessel design and manufacturing standards;

2) manufacturing an integral pipeline structure: welding reinforcing circular ring bodies on inner sides of the large flanges, the reinforcing circular ring bodies being in close fit with a circumference of an outer side of the straight cylindrical pipe body, circumferentially welding a group of girth welding joints between the reinforcing circular ring bodies and the circumference of the outer side of the straight cylindrical pipe body, circumferentially welding a group of girth welding joints between the reinforcing circular ring bodies and the large flanges, and assembling to form pipeline components capable of reinforcing the positions of the large flanges;

the reinforcing circular ring bodies are used for guaranteeing that the faces of the large flanges are not deformed during repetitive high-temperature sintering, and the thickness of steel plates thereof can be set, adjusted and increased according to the magnitude of the nominal diameter of the pipeline;

3) manufacturing reinforcing rebar plates: welding a plurality of groups of symmetrically distributed reinforcing rebar plates on the circumference of the outer side of the straight cylindrical pipe body, the reinforcing rebar plates being also welded with the reinforcing circular ring bodies;

the number of the reinforcing rebar plates is 9-21 groups and is selected according to the size of the diameter of the pipeline; and the reinforcing circular ring bodies are combined with 9-21 groups of symmetrical reinforcing rebar plates such that the nominal pressure of the large flanges of the pipeline and the sealing performance of the mouth of the pipeline can be perfectly improved;

4) manufacturing reinforcing steel circular pipe fittings: welding a plurality of groups of symmetrically distributed reinforcing steel circular pipe fittings, which are arranged between the two groups of reinforcing rebar plates, on the circumference of the outer side of the straight cylindrical pipe body, two ends of the reinforcing steel circular pipe fittings being respectively welded with an outer wall of the straight cylindrical pipe body and the reinforcing circular ring bodies;

the number of the reinforcing steel circular pipe fittings is 3-6; and the reinforcing steel circular pipe fittings greatly improve the deformation-resistant strength of the integral pipeline;

5) coating glass lining prime coat on the inner wall and the outer wall of the straight cylindrical pipe body, the faces of the large flanges, the reinforcing circular ring bodies, the reinforcing rebar plates and the reinforcing steel circular pipe fittings (combinations of the reinforcing circular ring bodies, the reinforcing rebar plates and the reinforcing steel circular pipe fittings are integral outer structural assemblies);

6) coating micro-crystallized glass lining finish coat on the inner wall and the outer wall of the straight cylindrical pipe body, the faces of the large flanges, the reinforcing circular ring bodies, the reinforcing rebar plates and the reinforcing steel circular pipe fittings (combinations of the reinforcing circular ring bodies, the reinforcing rebar plates and the reinforcing steel circular pipe fittings are integral outer structural assemblies);

combinations of the micro-crystallized glass lining finish coat are glass lining slurry obtained by mixing and grinding microcrystalline and amorphous glass lining in different formulas and proportions according to demands of the highest technical quality indexes corresponding to specific physiochemical performance of each oil and gas pipeline project;

7) adopting an openable and closeable extra-long horizontal electric heating furnace combined with an intelligent temperature program control/adjustment/recording instrument device to implement a heating-while-rotating sintering process in a combined manner to sinter the pipeline coated with the glass lining, controlling heating temperature between the glass lining prime coat and the micro-crystallized glass lining finish coat. between the micro-crystallized glass lining finish coat and the micro-crystallized glass lining finish coat to be consistent, and performing synchronous integral sintering;

a newly and innovatively developed openable and closeable extra-long horizontal electric heating furnace with an intelligent temperature program control/adjustment/recording instrument device is adopted to implement a controlled sintering “core technique” to the dried glass lining layers coated on the whole body of the pipeline, so as to form optimum and firmest wire-mesh-shaped adherence layers between steel plates and glass lining prime coat, lay a foundation for precisely implementing synchronous integral sintering between the glass lining prime coat and the micro-crystallized glass lining finish coat and between the micro-crystallized glass lining finish coat and the micro-crystallized glass lining finish coat at the same heating temperature, thoroughly eliminate various potential hazards and defects to the utmost extent and realize the highest quality index of zero pinhole;

the controlled sintering “core technique” refers to a controlled sintering process implementing medium-temperature pre-sintering, high-temperature sintering and heat preserving stages during sintering of the glass lining prime coat on the whole body of the pipeline. Sintering temperature can be room temperature to 950° C., and total sintering time is 5-6 h;

8) repetitively sintering the pipeline by adopting the sintering method in step 7), and coating glass lining on the pipeline before sintering at each time;

the glass lining layers of the large micro-crystallized glass-lined pipeline are repetitively sintered by adopting the newly and innovatively developed openable and closeable extra-long horizontal electric heating furnace combined with the intelligent temperature program control/adjustment/recording instrument device, and the glass lining layers need to be firstly coated to the whole body of the pipeline and then be dried before sintering at each time;

9) cooling the pipeline sintered at the last time together with the furnace according to a specific temperature lowering curve.

The specific temperature lowering curve can be set according to conversion from a soft state to a solid state of the micro-crystallized glass lining layers, and the pipeline is slowly cooled from furnace temperature 650° C. to 150° C. within 6-8 h.

The glass lining prime coat used in steps 5), 6), 7) and 8) is common glass lining slurry in the prior art and the micro-crystallized glass lining finish coat is glass lining slurry obtained by mixing and grinding microcrystalline and amorphous glass lining in different formulas and proportions. More preferably, the glass lining slurry can be coated by using a full-automatic slurry coating apparatus.

In steps 7), 8) and 9), by using the newly and innovatively developed openable and closeable extra-long horizontal electric heating furnace with the intelligent temperature program control/adjustment/recording instrument device, the measurement and control accuracy of the system can reach ±1° C., and the optimum sintering process of the glass lining layers of the pipeline can be comprehensively and precisely controlled and realized. The controlled sintering “core technique” is strictly followed, specific temperature at each stage of rising temperature, preserving heat and lowering temperature is precisely controlled, and a computer is used for executing the recording, printing and filing of the sintering process curve.

Further, in step 5), a controlled sintering “core technique” is executed after coating the glass lining prime coat on the inner wall and the outer wall of the straight cylindrical pipe body, the faces of the large flanges, the reinforcing circular ring bodies, the reinforcing rebar plates and the reinforcing steel circular pipe fittings, medium-temperature pre-sintering, heat preserving and high-temperature sintering can be precisely controlled, and formation of firm wire-mesh-shaped adherence layers between the outer walls of steel materials and the glass lining prime coat is promoted.

Further, by using the excellent physiochemical performance of the glass lining in combination with the advantage of above-level-8 Mohs hardness of the microcrystalline glass lining, formulas and proportions of microcrystalline and amorphous glass lining can be adopted and adjusted according to each oil and gas pipeline project line and especially demands of specific physiochemical performance such as acid resistance, alkali resistance, wear resistance and seismic and mechanical strength reinforcement of different structural parts of the same pipeline, so as to specially formulate the first highest technical quality index for the oil and gas pipeline project of the entire line to comprehensively improve, reinforce and guarantee smooth circulation, durability, anticorrosion and safety operation.

Further, micro-crystallized glass lining layers mainly consisting of microcrystalline glass lining are coated and sintered on several first deep layers of the inner wall of the straight cylindrical pipe body to greatly reinforce the mechanical strength, and micro-crystallized glass lining layers mainly consisting of amorphous glass lining are coated and sintered on several last surface layers to improve surface smoothness, corrosion resistance and wear resistance.

Further, micro-crystallized glass lining layers mainly consisting microcrystalline glass lining are coated and sintered on the outer wall of the straight cylindrical pipe body, the reinforcing circular ring bodies, the reinforcing rebar plates and the reinforcing steel circular pipe fittings to improve corrosion resistance and seismic and mechanical strength.

Further, micro-crystallized glass lining layers mainly consisting of microcrystalline glass lining are coated and sintered on the faces of the large flanges at the two ends of the pipeline to greatly reinforce the mechanical strength.

Further, in step 7), the openable and closeable extra-long horizontal electric heating furnace is combined with an intelligent temperature program control/adjustment/recording instrument device, and the openable and closeable extra-long horizontal electric heating furnace comprises a group of fixed horizontal bottom electric heating furnace in a shape of a semicircular ring body, two groups of openable and closeable horizontal electric heating furnaces in a shape of a ¼ circular ring body and two groups of circular plane electric heating furnaces; the two groups of openable and closeable horizontal electric heating furnaces in the shape of the ¼ circular ring body are arranged at an upper portion of the fixed horizontal bottom electric heating furnace in the shape of the semicircular ring body, and in a closed state, the two groups of openable and closeable horizontal electric heating furnaces in the shape of the ¼ circular ring body and the fixed horizontal bottom electric heating furnace in the shape of the semicircular ring body form a circular ring body; and the two groups of circular plane electric heating furnaces are arranged at two ends of the internal portion of the fixed horizontal bottom electric heating furnace in the shape of the semicircular ring body and the two groups of openable and closeable horizontal electric heating furnaces in the shape of the ¼ circular ring body.

Further, the two groups of openable and closeable horizontal electric heating furnaces in the shape of the ¼ circular ring body are any one selected from the following openable and closeable mechanical structural devices:

openable and closeable mechanical structural devices of type one:

bottoms of two ends of steel shells of the two groups of openable and closeable horizontal electric heating furnaces in the shape of the ¼ circular ring body being provided with more than four groups of rotatable connecting parts, and circular ring bodies of the steel shells of the two groups of openable and closeable horizontal electric heating furnaces in the shape of the ¼ circular ring body being provided with more than four groups of opening and closing parts; and

openable and closeable mechanical structural devices of type two:

horizontal bottoms of steel shells of the two groups of openable and closeable horizontal electric heating furnaces in the shape of the ¼ circular ring body being provided with sliding parts, and two sides of the two groups of openable and closeable horizontal electric heating furnaces in the shape of the ¼ circular ring body being provided with horizontal sliding rails allowing the sliding parts to horizontally slide.

Further, the openable and closeable extra-long horizontal electric heating furnace further comprises two groups of pipeline positioning pieces, the two groups of pipeline positioning pieces are arranged between the circular plane electric heating furnaces and the fixed horizontal bottom electric heating furnace in the shape of the semicircular ring body, each pipeline positioning piece comprises an inner circular ring, an outer circular ring and a plurality of groups of symmetrical circular rebars, the inner circular ring and the outer circular ring are two groups of concentric all-steel circular rings with different diameters, and the plurality of groups of symmetrical circular rebars are arranged between the inner circular ring and the outer circular ring and are symmetrically distributed along the circumference. Further, the inner diameter of the inner circular rings of the pipeline positioning pieces is matched with the outer diameter of the large flanges of the pipeline for the purpose of connection. The pipeline positioning pieces are detachable, and a space formed by the outer circular rings and the plurality of symmetrical circular rebars of the pipeline positioning pieces can be used for operations of lifting the pipeline into and out of the furnace through big traveling cranes.

Further, the openable and closeable extra-long horizontal electric heating furnace further comprises four rotatable fixed pulleys and the four rotatable fixed pulleys are arranged on two sides of the outer circular rings of the two groups of pipeline positioning pieces. The four rotatable fixed pulleys are used for implementing a new heating-while-rotating sintering process during sintering of the glass lining layers of the pipeline. Bearings of the rotatable fixed pulleys are positioned outside the openable and closeable extra-long horizontal electric heating furnace, the rotatable fixed pulleys can be driven by a motor to rotate and the new heating-while-rotating sintering process is realized by driving the integral pipeline to rotate through the large flanges of the pipeline.

Further, the rotatable fixed pulleys are cylindrical gears, the openable and closeable extra-long horizontal electric heating furnace further comprises four cylindrical gears, and the four cylindrical gears are arranged on the two sides of the outer circular rings of the two groups of pipeline positioning pieces. Bearings of the cylindrical gears are positioned outside the openable and closeable extra-long horizontal electric heating furnace, the cylindrical gears can be driven by a motor and the new heating-while-rotating sintering process is realized by driving the integral pipeline to rotate through the large flanges of the pipeline.

Further, the two groups of circular plane electric heating furnaces correspond to sintering of micro-crystallized glass lining layers mainly consisting of microcrystalline glass lining on the faces of the large flanges at the two ends of the pipeline, the four rotatable fixed pulleys driving the two groups of pipeline positioning pieces to rotate are combined with the intelligent temperature program control/adjustment/recording instrument device having temperature control accuracy of ±1° C., requirements of a specific high-standard microcrystalline glass lining sintering process are comprehensively and perfectly satisfied, and an extra-large and extra-long large micro-crystallized glass lining oil and gas pipeline which is excellent in quality and safe in operation is innovatively manufactured.

Further, chamber walls of integral inner chambers of the fixed horizontal bottom electric heating furnace in the shape of the semicircular ring body and the two groups of openable and closeable horizontal electric heating furnaces in the shape of the ¼ circular ring body are provided with coaxial arc-shaped heat conducting plates which are made of heat-resistant steel. The coaxial arc-shaped heat conducting plates cover the surface layer of the openable and closeable extra-long horizontal electric heating furnace to improve the heating uniformity of the openable and closeable extra-long horizontal electric heating furnace.

Further, an integral circular ring body horizontal electric heating furnace formed by the fixed horizontal bottom electric heating furnace in the shape of the semicircular ring body and the two groups of openable and closeable horizontal electric heating furnaces in the shape of the ¼ circular ring body corresponds to the sintering of the micro-crystallized glass lining layers on the inner wall and outer wall of the straight cylindrical pipe body of the pipeline and integral outer structural assemblies, the two groups of circular plane electric heating furnaces correspond to the sintering of the micro-crystallized glass lining layers on the faces of the large flanges at the two ends of the pipeline, and corresponding different micro-crystallized glass lining and different sintering temperature can be adopted and adjusted according to demands of specific physiochemical performance and high-standard technical quality of different structural parts of the same pipeline.

Further, a half circumferential wall of an inner side of the fixed horizontal bottom electric heating furnace in the shape of the semicircular ring body is provided with a plurality of ½ ring grooves; an electric heating ribbon is wound in the ½ ring grooves; ¼ circumferential walls of inner sides of the openable and closeable horizontal electric heating furnaces in the shape of the ¼ circular ring body are provided with a plurality of ¼ ring grooves; electric heating ribbons are wound in the ¼ ring grooves; the electric heating ribbon wound in the ½ ring grooves and the electric heating ribbons wound in two of the ¼ ring grooves are circumferentially connected to form a group of electric heating ribbons, and the integral circular ring body horizontal electric heating furnace consists of a plurality of groups of electric heating ribbons; circular planes of the circular plane electric heating furnaces are provided with a plurality of loops of concentric circular grooves with different diameters; a group of electric heating ribbons are wound in the concentric circular grooves; each group of the electric heating ribbon is connected with a temperature control system, and the temperature control system comprises a group of thermocouples and an intelligent temperature program control/adjustment/recording instrument device. Two major temperature control systems formed by the integral circular ring body horizontal electric heating furnace and the two groups of circular plane electric heating furnaces can respectively adjust heating power, and precisely implement synchronous integral sintering of different micro-crystallized glass lining layers of different structural parts of the pipeline at different sintering temperature, the same micro-crystallized glass lining layers of the same structural part at the same sintering temperature and the integral micro-crystallized glass lining layers of the same pipeline.

Further, the group of thermocouples are matched with a group of electric heating ribbons, arranged in a heating area of the group of electric heating ribbons and used for detecting the heating temperature of the micro-crystallized glass lining layers of the pipeline in the heating area of the electric heating ribbons and send out temperature signals; and the intelligent temperature program control/adjustment/recording instrument device is arranged outside the openable and closeable extra-long horizontal electric heating furnace, connected with the group of electric heating ribbons matched with the group of thermocouples and executes automatic printing, recording, filing and quality tracking during sintering.

Further, the integral circular ring body horizontal electric heating furnace and the two groups of circular plane electric heating furnaces form two major temperature control systems, which are respectively and independently connected with a group of electric heating ribbons and a group of corresponding thermocouples and are respectively combined with the intelligent temperature program control/adjustment/recording devices to respectively and independently adjust heating power, set temperature accuracy to be ±1° C. and precisely implement synchronous integral sintering of the micro-crystallized glass lining layers with different compositions of different structural parts of the pipeline at different sintering temperature and the integral micro-crystallized glass lining layers with different compositions of the same pipeline.

The intelligent temperature program control/adjustment/recording device stores a preset temperature or temperature control curve therein, and is used for receiving temperature signals of the thermocouples and adjusting the heating temperature of the electric heating ribbons after comparison with the preset temperature or temperature control curve.

Since each group of electric heating ribbons can be independently matched with a temperature control system, the heating power of each group of electric heating ribbons can be independently adjusted. The intelligent temperature program control/adjustment/recording instrument device can precisely realize temperature presetting, temperature control and automatic recording.

A first feature of the openable and closeable extra-long horizontal electric heating furnace is: comprising a group of fixed horizontal bottom electric heating furnace in a shape of a semicircular ring body, two groups of openable and closeable horizontal electric heating furnaces in a shape of a ¼ circular ring body and two groups of circular plane electric heating furnaces, the two groups of openable and closeable horizontal electric heating furnaces in the shape of the ¼ circular ring body being arranged at an upper portion of the fixed horizontal bottom electric heating furnace in the shape of the semicircular ring body, and the two groups of circular plane electric heating furnaces being arranged at two ends of the fixed horizontal bottom electric heating furnace in the shape of the semicircular ring body and the two groups of openable and closeable horizontal electric heating furnaces in the shape of the ¼ circular ring body; and further, bottoms of two ends of steel shells of the two groups of openable and closeable horizontal electric heating furnaces in the shape of the ¼ circular ring body being provided with more than four groups of rotatable connecting parts and circular ring bodies of the steel shells of the two groups of openable and closeable horizontal electric heating furnaces in the shape of the ¼ circular ring body being provided with more than four groups of opening and closing parts to execute opening and closing of the two groups of openable and closeable horizontal electric heating furnaces in the shape of the ¼ circular ring body; or horizontal bottoms of steel shells of the two groups of openable and closeable horizontal electric heating furnaces in the shape of the ¼ circular ring body being provided with sliding parts, and two sides of the two groups of openable and closeable horizontal electric heating furnaces in the shape of the ¼ circular ring body being provided with horizontal sliding rails allowing the sliding parts to horizontally slide to execute opening and closing of the two groups of openable and closeable horizontal electric heating furnaces in the shape of the ¼ circular ring body.

A second feature of the openable and closeable extra-long horizontal electric heating furnace is: chamber walls of integral inner chambers of the fixed horizontal bottom electric heating furnace in the shape of the semicircular ring body and the two groups of openable and closeable horizontal electric heating furnaces in the shape of the ¼ circular ring body being provided with coaxial arc-shaped heat conducting plates which are made of heat-resistant steel, and the coaxial arc-shaped heat conducting plates cover the surface layer of the openable and closeable extra-long horizontal electric heating furnace to improve the heating uniformity of the openable and integral electric heating furnace; and intelligent temperature program control/adjustment/recording instrument devices being adopted in a combined manner to greatly improve the overall quality of the large micro-crystallized glass-lined pipeline with the micro-crystallized glass lining layers on the inner wall and outer wall of the straight cylindrical pipe body which are synchronously and integrally sintered at the same heating temperature.

A third feature of the openable and closeable extra-long horizontal electric heating furnace is: two groups of circular plane electric heating furnaces and intelligent temperature program control/adjustment/recording instrument devices being arranged at two ends of the fixed horizontal bottom electric heating furnace in the shape of the semicircular ring body and the two groups of openable and closeable horizontal electric heating furnaces in the shape of the ¼ circular ring body to control the synchronous integral sintering of the micro-crystallized glass lining layers on the faces of the large flanges at the two ends of the pipeline at the same heating temperature.

The shape of the integral structure of the openable and closeable extra-long horizontal electric heating furnace is matched and consistent with the shape of the integral structure of the pipeline, and the integral circular ring body horizontal electric heating furnace (a combination of the group of fixed horizontal bottom electric heating furnace in the shape of the semicircular ring body and the two groups of openable and closeable horizontal electric heating furnaces in the shape of the ¼ circular ring body) and the circular plane electric heating furnaces on two sides respectively correspond to the micro-crystallized glass lining layers on the straight cylindrical pipe body of the pipe and the surfaces of the flanged big flanges at the two ends.

By adopting the intelligent temperature program control/adjustment/recording instrument devices and the openable and closeable extra-long horizontal electric heating furnace, the temperature control accuracy of the system is ±1° C., the medium-temperature pre-sintering, high-temperature sintering, heat preserving and stage-by-stage controlled sintering “core technique” can be scientifically, precisely and comprehensively implemented, the physical and chemical reaction of steel materials can be strictly followed, and optimum and perfect physical and chemical reaction for the purposes of firm combination between iron blanks of the pipeline, compactness and smoothness can be realized between steel materials and glass lining prime coat, between glass lining prime coat and glass lining finish coat and between glass lining finish coat and glass lining finish coat, so as to thoroughly eliminate various defects in the glass lining layers to the utmost extent, realize the highest quality index of zero pinhole and greatly improve the overall quality and service life of the large micro-crystallized glass-lined pipeline.

To sum up, the present invention has the following beneficial effects:

The present invention is a special large micro-crystallized glass-lined oil and gas long-distance transportation pipeline which is strong in integral pipeline corrosion resistance, strong in wear resistance, smooth on surfaces, smooth in circulation, non-deformable in integral pipeline structure members and strong in seismic resistance, plays an important role irreplaceable by any existing oil and gas pipeline, and guarantees fewer pipeline project installation and connection points, good sealing performance, maximum size and length, durability, anticorrosion, smooth circulation, high quality and safety operation.

Integral structural members of each large micro-crystallized glass-lined pipeline provided by the present invention can be designed and manufactured in accordance with TSGD0001-2009 Supervision Regulations on Safety Technology of Pressure Pipelines—Industrial Pipelines. Reinforcing circular ring bodies matched with the large flanges are respectively welded on the inner sides of the large flanges formed by flanging the two ends of the pipeline, the integral structural members of the pipeline further comprise a plurality of symmetrical reinforcing rebar plates, and the plurality of symmetrical reinforcing rebar plates are arranged on the reinforcing circular ring bodies and the outer wall of the pipeline and are symmetrically welded along the circumference of the outer wall of the pipeline, so as to obviously improve the nominal pressure and sealing performance of the faces of the large flanges of the pipeline. Further, the structural members of the pipeline further comprise a plurality of groups of reinforcing steel circular pipe fittings which are symmetrical on the whole which are arranged on the reinforcing circular ring bodies of the faces of the large flanges at the two ends, are positioned between a plurality of groups of symmetrical reinforcing rebar plates and are welded in a manner of being in axial symmetry about the outer wall of the pipeline on the whole, so as to obviously improve the nominal pressure of the faces of the large flanges at the two ends of the pipeline and the deformation resistance performance of the integral pipeline. The integral structural members of the pipelined can guarantee that the pipeline is definitely not deformed after repetitive high-temperature sintering, so as to perfectly improve the nominal pressure and sealing performance of the faces of the large flanges, prevent the integral pipeline from being deformed and improve and reinforce the mechanical strength related to the seismic performance and the safety operation.

Due to the excellent physiochemical performance in combination with the advantage of above-level-8 Mohs hardness of the microcrystalline glass lining layers, glass lining is a medium material which is irreplaceable by any material medium composite layers combined with the iron blanks of pipelines in the current science and technology and is unique, the most ideal and the most perfect for making oil and gas pipelines. The surface of the inner wall of the pipeline is guaranteed to be durable, anticorrosive and wear-resistant; the deep layers of the inner wall and the faces of the large flanges at the two ends of the pipeline have extremely high seismic and mechanical strength; the outer wall of the pipeline is not corroded and stripped; and the integral pipeline structure is not deformed and has extremely high seismic and mechanical strength. The large micro-crystallized glass-lined pipeline is guaranteed to be durable, anticorrosive, wear-resistant, smooth in circulation and safe in operation.

The large micro-crystallized glass-lined pipeline provided by the present invention takes smooth circulation, durability, anticorrosion and safety operation as a first technical quality index, and different formulas and proportions of microcrystalline and amorphous glass lining and different sintering temperature can be adopted, adjusted and formulated according to specific demands such as acid resistance, alkali resistance, wear resistance improvement and seismic and mechanical strength reinforcement of each oil and gas pipeline project line and especially different structural parts of the same pipeline. A breakthrough is successfully made in the trend of more serious corrosion due to complex compositions and great pH value change of transported oil and gas mediums, the problems of crack, poor seismic and mechanical strength and integral pipeline deformation due to environmental soil stress, and the increasingly outstanding problems of serious pipeline corrosion and low operation safety.

According to the large micro-crystallized glass-lined pipeline provided by the present invention, by using the irreplaceable excellent physiochemical performance of the glass lining in combination with the advantage of above-level-8 Mohs hardness of the microcrystalline glass lining, different mixing proportions and different sintering temperature of corresponding microcrystalline and amorphous glass lining can be adopted and adjusted according to specific demands of each oil and gas transportation pipeline project, further the micro-crystallized glass lining layers mainly consisting of microcrystalline glass lining capable of reinforcing the mechanical strength can be coated and sintered on the deep layers of the inner wall of the same pipeline, and the micro-crystallized glass lining layers mainly consisting of amorphous glass lining capable of resisting corrosion and wear and forming smooth surfaces can be coated and sintered on the surface layers of the inner wall of the pipeline; the micro-crystallized glass lining layers mainly consisting of microcrystalline glass lining capable of improving seismic and mechanical strength and resisting corrosion can be coated and sintered on the outer wall of the pipeline; and the micro-crystallized glass lining layers mainly consisting of microcrystalline glass lining capable of greatly reinforcing mechanical strength can be coated and sintered on the faces of the large flanges at the two ends of the pipeline, so as to avoid the situation that the glass lining layers on the faces of the large flanges are cracked due to great force for tightening bolts, and comprehensively improve, reinforce and guarantee the durability, anticorrosion, wear resistance, smooth circulation and safety operation of the large micro-crystallized glass-lined oil and gas pipelines of the entire line.

The innovative technical core and major breakthrough of the present invention are a group of openable and closeable extra-long horizontal electric heating furnace in combination with a new heating-while-rotating sintering process implemented during heating and sintering of the micro-crystallized glass lining of the pipeline, and the high-quality large micro-crystallized glass-lined pipeline with diameter greater than 1 m and length greater than 25 m is manufactured. Two large travelling cranes are used for performing synchronous operations of putting/taking the pipeline into/out of the furnace, only the two groups of openable and closeable horizontal electric heating furnaces in the shape of ¼ circular ring body at the upper portion need to be opened, firstly one traveling crane is used to lift the heated and sintered glass-lined pipeline out of the electric furnace, then the other traveling crane is used to lift the glass-lined pipeline to be heated and sintered into the electric furnace, finally the horizontal electric heating furnaces are closed. The operation is convenient and efficient to perform. This electric heating furnace can be called as a unique, irreplaceable, effective and high-efficiency electric heating furnace, and this is a major breakthrough in the development history of the glass lining industry.

The present invention adopts the innovatively developed openable and closeable extra-long horizontal electric heating furnace combined with the intelligent temperature program control/adjustment/recording instruments which are connected with each group of electric heating ribbons and each group of thermocouples and are capable of independently adjust the heating power, the micro-crystallized glass lining layers of the pipeline slowly rotate during sintering, and the temperature control accuracy of the system reaches ±1° C., so as to implement the synchronous integral sintering of the micro-crystallized glass lining layers with different compositions of different structural parts of the same pipeline at different sintering temperature, the micro-crystallized glass lining layers with the same composition of the same structural part at the same sintering temperature and the integral micro-crystallized glass lining layers of the same pipeline to the utmost extent. In combination with the new controlled sintering “core technique” process, deep development towards the directions of thoroughly eliminating various potential defects such as invisible bubbles, cracks, slurry flowing and lining layer burst in the glass lining layers to the utmost extent and realizing the highest quality index of zero pinhole is realized, the overall quality of the large micro-crystallized glass-lined pipeline is greatly improved, the service life and safety operation of the product are obviously increased and this is another major breakthrough in the development history of the glass lining industry.

A first feature of the openable and closeable extra-long horizontal electric heating furnace is: two groups of mechanical devices, i.e., slidably openable and closeable or rotatably openable and closeable electric heating furnaces in a shape of ¼ circular ring body are arranged, such that the problem of putting/taking the extra-large and extra-long glass-lined pipeline into/out of the furnace is smoothly solved and the two major breakthroughs are made thereby; a second feature is: the integral circular ring body electric heating furnace formed by a group of fixed horizontal bottom electric heating furnace in a shape of a semicircular ring and two groups of openable and closeable horizontal electric heating furnaces in a shape of ¼ circular ring corresponds to the sintering of the integral micro-crystallized glass lining layers of the straight cylindrical pipe body of the pipeline, and two groups of circular plane electric heating furnaces correspond to the sintering of the micro-crystallized glass lining layers on the faces of the large flanges at the two ends of the pipeline, such that different sintering temperature of the micro-crystallized glass lining layers with different compositions can be realized according to the specific demands of different physiochemical performances of different structural parts of the same pipeline; and a third feature is: four rotatable fixed pulleys capable of enabling the positioning pieces at the two ends of the pipeline to slowly rotate are arranged at the bottom of the inner chamber of the electric heating furnace, such that definitely no deformation of the integral pipeline and the surfaces of the flanges at the two ends and the heating uniformity of the integral micro-crystallized glass lining layers of the pipeline are perfectly guaranteed. Especially, the two groups of fixed circular plane electric heating furnaces correspond to the glass lining layers mainly consisting of the microcrystalline glass lining on the faces of the large flanges at the two ends of the pipeline, such that the problem that it is very difficult to manufacture larger glass-lined equipment due to small sintering temperature range and glass lining flowing since the microcrystalline glass lining was invented is solved. By combining the two major advantages of the openable and closeable electric heating furnace and by implementing the new heating-while-rotating sintering process through the high-accuracy temperature control system, the specific demands of the high-standard sintering process of the microcrystalline glass lining can be comprehensively and perfectly satisfied, and the mechanical strength and thermal performance can be doubly increased for the upgrading and application of the microcrystalline glass lining; and by combining the micro-crystallized glass lining with the excellent physiochemical performance of the amorphous high-silica glass lining, new-generation large micro-crystallized glass-lined equipment is innovatively manufactured, the big revolution of the modern glass lining industry is strongly impulse, and this is the unique and irreplaceable major breakthrough in the openable and closable extra-long horizontal electric heating furnace for the purpose of developing and manufacturing an extra-large and extra-long large micro-crystallized glass-lined pipeline which is high in quality and safe in operation.

A first feature of manufacturing of the large micro-crystallized glass-lined pipeline is: corresponding technical quality indexes can be designed and formulated according to specific demands of different physiochemical performance such as acid resistance, alkali resistance, wear resistance improvement and seismic and mechanical strength reinforcement of each oil and gas pipeline project, such that the major technical quality problem related to the safety operation of the pipeline due to complex compositions of current exploited petroleum mediums, great pH change and serious corrosion caused by environmental soil stress is comprehensively solved; a second feature is: the formulas and proportions of the different micro-crystallized glass lining can be adopted and adjusted according to specific demands of different physiochemical performance of different structural parts of the same pipeline, micro-crystallized glass lining layers mainly consisting of microcrystalline glass lining capable of reinforcing mechanical strength should be adopted on the deep layers of the inner wall of the pipeline, micro-crystallized glass lining layers mainly consisting of amorphous glass lining capable of resisting corrosion and wear and forming smooth surfaces should be adopted on the surface layers of the inner wall, micro-crystallized glass lining layers mainly consisting of microcrystalline glass lining capable of improving seismic and mechanical strength and resisting corrosion should be adopted on the outer wall of the pipeline and micro-crystallized glass lining layers mainly consisting of microcrystalline glass lining capable of greatly improving mechanical strength should be adopted on the faces of the large flanges at the two ends of the pipeline; and a third feature is: due to excellent physiochemical performance, glass lining is widely applied to manufacturing of chemical and pharmaceutical container equipment and is a unique, the most perfect and the most ideal composite medium material of the surface layers of the iron blanks of the pipeline in the science and technology at present, and in combination with the advantage of above-level-8 Mohs hardness of the microcrystalline glass lining, the pipeline can be guaranteed to be durable, anticorrosive, wear-resistant, smooth in surfaces, smooth in circulation, strong in seismic and mechanical performance and safe in operation; especially for the development of large micro-crystallized glass-lined oil and gas pipeline projects, by calculating according to total length of 2000 km per project and length of 25 m per pipeline, there are 80000 flange surface connection points; and the realization and guarantee of the mechanical strength quality index of the glass lining on the surfaces of the flanges of each pipeline have a direct connection with the safety operation of the oil and gas pipeline; a fourth feature is: for the manufacturing of the large micro-crystallized glass-lined pipeline, by combining and adopting the intelligent temperature program control/adjustment/recording device, the temperature control accuracy of the system is ±1° C., the heating power can be respectively and independently adjusted, and the synchronous integral sintering of the micro-crystallized glass lining layers with different compositions of different structural parts of the pipeline at different sintering temperature, the micro-crystallized glass lining layers with the same compositions of the same structural part at the same sintering temperature and the integral micro-crystallized glass lining layers of the same pipeline can be precisely implemented; and by implementing the controlled sintering “core technique” in a combined manner, various potential defects such as invisible bubbles, cracks, slurry flowing and lining layer burst in the glass lining layers can be thoroughly eliminated to the utmost extent, so as to greatly promote the deep development towards the directions of performing standard detection in accordance with the new national standard GB25025-2010 Technical Conditions for Glass-lined Equipment, guaranteeing the faces of the large flanges of the pipeline to be not deformed and realizing the highest quality index of zero pinhole in the glass lining layers; and a fifth feature is: by taking various technical quality indexes in the current national standard GB25025-2010 Technical Conditions for Glass-lined Equipment as standards, the inventor introduces and adopts the microcrystalline glass lining capable of greatly improving the mechanical strength and thermal performance according to the specific demands of physiochemical performance of oil and gas pipeline projects, and drafts and formulates Technical Conditions for Glass-lined Pipelines to greatly improve various physiochemical performance under the criterion taking seismic and mechanical strength as the highest quality index, including new indexes that the large flanges of the pipeline are not deformed and the number of pinholes in the glass lining layers is zero. The pipeline is guaranteed to have the comprehensive advantages of durability, anticorrosion, high wear resistance, smooth surface, smooth circulation, high seismic and mechanical strength and safety operation, various existing pipelines which were constructed at early stages but have already been seriously corroded are comprehensively replaced, and the safe and high-efficiency development of the large micro-crystallized glass-lined pipeline manufactured and invented by China is promoted.

### BRIEF DESCRIPTION OF THE DRAWINGS

FIG. 1 is a schematic view of micro-crystallized glass lining layers of a large micro-crystallized glass-lined pipeline;

FIG. 2 is a schematic view of an integral structure of a large micro-crystallized glass-lined pipeline;

FIG. 2a1 is a structural schematic view of reinforcing circular ring bodies 2a, a plurality of groups of symmetrical reinforcing rebar plates 2b and a plurality of groups of reinforcing steel circular pipe fittings 2c on large flanges 2B which are circumferentially and symmetrically combined and welded;

FIG. 2a2 is a structural schematic view of large flanges 2B and two groups of reinforcing circular ring bodies 2a which are welded in a circular ring shape and are welded along an circumference of an outer wall of a pipeline;

FIG. 2a3 is a structural schematic view of a plurality of groups of symmetrical reinforcing rebar plates 2b which are respectively, symmetrically and uniformly distributed and welded with reinforcing circular ring bodies 2a at two ends of large flanges;

FIG. 2a4 is a structural schematic view of the plurality of groups of reinforcing steel circular pipe fittings 2c and reinforcing circular ring bodies 2a at two ends of a pipeline which are axially and integrally welded along an outer wall of a pipeline and are distributed between the plurality of groups of reinforcing rebar plates 2b;

FIG. 2a5 is a partial enlarged schematic view of circumferentially welded girth welding joints between reinforcing circular ring bodies 2a and a circumference of an outer side of a straight cylindrical pipe body 2 and circumferentially welded girth welding joints between reinforcing circular ring bodies 2a and large flanges 2B;

FIG. 3 is a schematic view of an integral structure of an openable and closeable extra-long horizontal electric heating furnace;

FIG. 3A is a schematic view of an openable and closeable structure of two groups of openable and closeable horizontal electric heating furnaces in a shape of a ¼ circular ring body;

FIG. 3A1 is a schematic view of a combined structure of a fixed horizontal bottom electric heating furnace in a shape of a semicircular ring body and two groups of circular plane electric heating furnaces and four rotatable fixed pulleys enabling pipeline positioning pieces at two ends to slowly rotate;

FIG. 3B is a schematic view of a first structure of an openable and closeable extra-long horizontal electric heating furnace combined through rotatable connecting parts and opening and closing parts;

FIG. 3C is a schematic view of a second structure of an openable and closeable extra-long horizontal electric heating furnace combined through sliding parts and horizontal sliding rails;

FIG. 4 is a schematic view of a structure of an openable and closeable extra-long horizontal electric heating furnace combined through rotatable connecting parts and opening and closing parts when a large micro-crystallized glass-lined pipeline is put in and taken out during sintering;

FIG. 4A is a schematic view of an integral structure of a large micro-crystallized glass-lined pipeline sintered in an openable and closeable extra-long horizontal electric heating furnace;

FIG. 5 is a structural schematic view when a pipeline is lifted into a horizontal electric heating furnace, is tightly connected with two groups of pipeline positioning pieces and is placed on four rotatable fixed pulleys during sintering of micro-crystallized glass lining layers of the pipeline;

FIG. 5A is a structural schematic view when a pipeline is lifted into a horizontal electric heating furnace and is connected with two groups of concentric pipeline positioning pieces during sintering of micro-crystallized glass lining layers of the pipeline;

FIG. 5B is a partial structural schematic view when large flanges of a pipeline lifted into a horizontal electric heating furnace and are tightly connected with two groups of pipeline positioning pieces during sintering of micro-crystallized glass lining layers of the pipeline;

FIG. 6 is a structural schematic view of a combination of an intelligent temperature program control/adjustment/recording instrument device (PID) and thermocouples, i.e., a temperature control system.

### REFERENCE SIGNS

1: large micro-crystallized glass-lined pipeline;
1a: micro-crystallized glass lining layer;
1a1: micro-crystallized glass lining layer on inner wall of pipeline;
1a2: micro-crystallized glass lining layer on surface of large flange of pipeline;
1a3: micro-crystallized glass lining layer on outer wall of pipeline and integral outer structural assembly of pipeline;
2: straight cylindrical pipe body;
2A: inner wall of straight cylindrical pipe body;
2B: large flange;
2B1-2B3, 2B5-2B7, 2B9-2B11: connecting hole in surface of large flange of pipeline;
2B4, 2B8, 2B12: bolt hole in surface of large flange of pipeline;
2C: outer wall of straight cylindrical pipe body;
2C1: integral outer structural assembly;
2a: reinforcing circular ring body;
2b, 2b1-2b9: reinforcing rebar plate;
2c, 2c1-2c3: reinforcing steel circular pipe fitting;
2e: girth welding joint;
3: openable and closeable extra-long electric heating furnace;
3.1: a group of fixed horizontal bottom electric heating furnace in a shape of a circular ring body;
3.2: two groups of openable and closeable horizontal electric heating furnace in a shape of a ¼ circular ring body;
3.3: circular plane electric heating furnaces fixed at two ends of integral circular ring body horizontal electric heating furnace;
3.4: integral circular ring body horizontal electric heating furnace formed by a fixed horizontal bottom electric heating furnace 3.1 in a shape of a semicircular ring body and two groups of openable and closeable horizontal electric heating furnaces
3.2 in a shape of a ¼ circular ring body;
3.5: four rotatable fixed pulleys on two sides driving micro-crystallized glass lining layers of pipeline to slowly rotate during sintering, bearings of which are positioned outside furnace body of openable and closeable extra-long horizontal electric heating furnace;
3a: refractory material layer;
3a1, 3a2, 3a3: refractory material layer
3b: electric heating ribbon;
3b1, 3b2, 3b3: electric heating ribbon;
3c: thermocouple;
3c1, 3c2, 3c3: thermocouple;
3d: heat preserving material layer of electric heating furnace;
3d1, 3d2, 3d3: heat preserving material layer of electric heating furnace;
3e: coaxial arc-shaped heat conducting plate;
3e1, 3e2: coaxial arc-shaped heat conducting plate;
3B1: rotatable connecting part;
3B2: opening and closing part;
3C1: sliding part;
3C2: horizontal sliding rail;
5: pipeline positioning piece;
5.1: inner circular ring of pipeline positioning piece;
5.2: outer circular ring of pipeline positioning piece;
5.3: a plurality of groups of symmetrical circular rebars;
5.4: three connecting steel plates;
6.1: intelligent temperature program control/adjustment/recording instrument device (PID).

### DETAILED DESCRIPTION OF THE PREFERRED EMBODIMENTS

The embodiments of the present invention will be described below through specific examples. One skilled in the art can easily understand other advantages and effects of the present invention according to contents disclosed by the description. The present invention can also be implemented or applied through other different specific embodiments. Various modifications or variations can be made to all details in the description based on different points of view and applications without departing from the spirit of the present invention.

In addition, it should be understood that one or more method steps mentioned in the present invention does not exclude the situation that other method steps can exist before and after the combined steps or other method steps can also be inserted between these clearly mentioned steps, unless otherwise stated; and it should also be understood that a combined connection relation of one or more equipment/devices mentioned in the present invention does not exclude the situation that other equipment/devices can exist before and after the combined equipment/devices or other equipment/devices can also be inserted between two equipment/devices of these clearly mentioned equipment/devices, unless otherwise stated. In addition, unless otherwise stated, a serial number of each method step is a convenient tool for distinguishing each method step and is not used for limiting an arrangement sequence of each method step or limiting the implementable range of the present invention, and change or adjustment of relative relations thereof should be viewed as the implementable range of the present invention under the situation that the technical contents are not substantively changed.

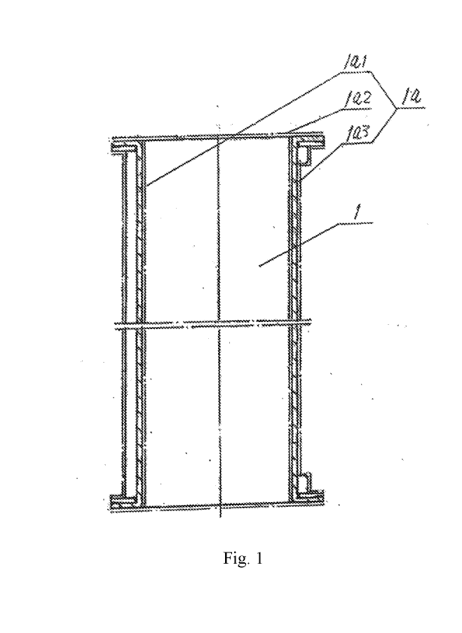

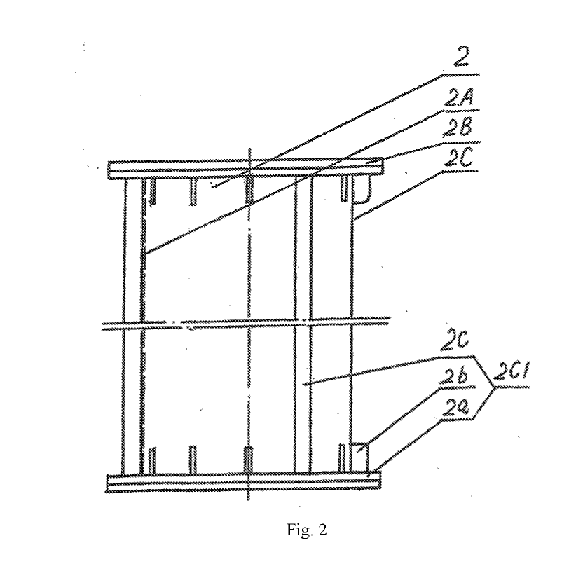

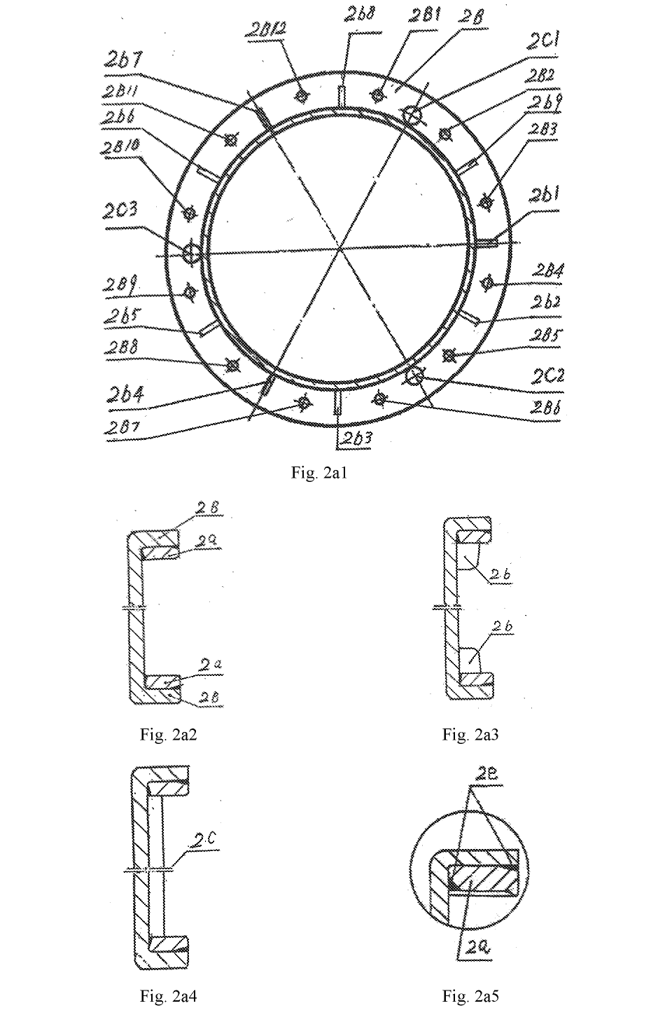

A large micro-crystallized glass-lined pipeline 1 as shown in FIG. 1 and FIG. 2 comprises a straight cylindrical pipe body 2, large flanges 2B and reinforcing circular ring bodies 2a, wherein two ends of the straight cylindrical pipe body 2 are flanged to form the large flanges 2B, the reinforcing circular ring bodies 2a are in close fit with a circumference of an outer side of the straight cylindrical pipe body 2 and are welded on inner sides of the large flanges 2B, and micro-crystallized glass lining layers 1a are coated and sintered on an inner wall 2A and an outer wall 2C of the straight cylindrical pipe body 2, outer sides of the large flanges 2B and outer sides of the reinforcing circular ring bodies 2a.

As shown in FIG. 2a1, FIG. 2a2 and FIG. 2a5, circumferentially welded girth welding joints 2e are formed between the reinforcing circular ring bodies 2a and the circumference of the outer side of the straight cylindrical pipe body 2, and circumferentially welded girth welding joints 2e are formed between the reinforcing circular ring bodies 2a and the large flanges 2B.

As shown in FIG. 2a1 and FIG. 2a3, the large micro-crystallized glass-lined pipeline further comprises reinforcing rebar plates 2b, the reinforcing rebar plates 2b are symmetrically distributed along the circumference of the outer side of the straight cylindrical pipe body 2, the reinforcing rebar plates 2b are welded on the circumference of the outer side of the straight cylindrical pipe body 2 and are welded with the reinforcing circular ring bodies 2a, and micro-crystallized glass lining layers 1a3 are coated and sintered on outer sides of the reinforcing rebar plates 2b. A number of the reinforcing rebar plates can be 9-21 groups, and as shown in FIG. 2a1, the number of the reinforcing rebar plates is totally 9 groups, i.e., 2b1-2b9.

As shown in FIGS. 2a1 and 2a4, the large micro-crystallized glass-lined pipeline further comprises reinforcing steel circular pipe fittings 2c, the reinforcing steel circular pipe fittings 2c are symmetrically distributed along the circumference of the outer side of the straight cylindrical pipe body 2 and are arranged between two groups of reinforcing rebar plates, two ends of the reinforcing steel circular pipe fittings 2c are respectively welded with the outer wall 2C of the straight cylindrical pipe body and the reinforcing circular ring bodies 2a, and micro-crystallized glass lining layers 1a3 are coated and sintered on outer sides of the reinforcing steel circular pipe fittings 2c. A number of the reinforcing steel circular pipe fittings 2c can be 3-6, and as shown in FIG. 2a1, the number of the reinforcing steel circular pipe fittings is totally 3, i.e., 2c1, 2c2 and 2c3.

The large micro-crystallized glass-lined pipeline is developed and manufactured by adopting a manufacturing method through an openable and closeable extra-long horizontal electric heating furnace combined with an intelligent temperature program control/adjustment/recording instrument device, the intelligent temperature program control/adjustment/recording instrument device has temperature control accuracy of ±1° C. and is combined with the openable and closeable extra-long horizontal electric heating furnace, and a heating-while-rotating sintering process is implemented in a combined manner.

The openable and closeable extra-long horizontal electric heating furnace 3 comprises a group of fixed horizontal bottom electric heating furnace 3.1 in a shape of a semicircular ring body, two groups of openable and closeable horizontal electric heating furnaces 3.2 in a shape of a ¼ circular ring body and two groups of circular plane electric heating furnaces 3.3; the two groups of openable and closeable horizontal electric heating furnaces 3.2 in the shape of the ¼ circular ring body are arranged at an upper portion of the fixed horizontal bottom electric heating furnace 3.1 in the shape of the semicircular ring body, and in a closed state, the two groups of openable and closeable horizontal electric heating furnaces 3.2 in the shape of the ¼ circular ring body and the fixed horizontal bottom electric heating furnace 3.1 in the shape of the semicircular ring body form a circular ring body; and the two groups of circular plane electric heating furnaces 3.3 are arranged at two ends of the fixed horizontal bottom electric heating furnace 3.1 in the shape of the semicircular ring body and the two groups of openable and closeable horizontal electric heating furnaces 3.2 in the shape of the ¼ circular ring body.

An integral circular ring body horizontal electric heating furnace 3.4 formed by the fixed horizontal bottom electric heating furnace 3.1 in the shape of the semicircular ring body and the two groups of openable and closeable horizontal electric heating furnaces 3.2 in the shape of the ¼ circular ring body corresponds to sintering of the micro-crystallized glass lining layers 1a1, 1a3 on the inner wall 2A and the outer wall 2C of the straight cylindrical pipe body 2 and integral outer structural assemblies 2C1 of the large micro-crystallized glass-lined pipeline, and the two groups of circular plane electric heating furnaces 3.3 correspond to sintering of the micro-crystallized glass lining layers 1a2 on the faces of the large flanges 2B at the two ends of the pipeline.

The micro-crystallized glass lining layer 1a1 on the inner wall 2A of the straight cylindrical pipe body, the micro-crystallized glass lining layers 1a3 on the outer wall 2C of the straight cylindrical pipe body and the integral outer structural assemblies 2C1 and the micro-crystallized glass lining layers 1a2 on the faces of the large flanges 2B at the two ends of the pipeline are different in compositions. According to the large micro-crystallized glass-lined pipeline provided by the present invention, by using the irreplaceable excellent physiochemical performance of the glass lining in combination with the advantage of above-level-8 Mohs hardness of the microcrystalline glass lining, different formulas and proportions of microcrystalline and amorphous glass lining and different sintering temperature of the micro-crystallized glass lining layers can be adopted and adjusted for each oil and gas transportation pipeline project and according to specific demands of different physiochemical performance of different structural parts of the same pipeline. Micro-crystallized glass lining layers 1a3 mainly consisting of microcrystalline glass lining capable of reinforcing seismic and mechanical strength are adopted on the outer wall 2C of the straight cylindrical pipe body 2 and the integral outer structural assemblies 2C1 of the pipeline; a micro-crystallized glass lining layer 1a1 mainly consisting of microcrystalline glass lining capable of reinforcing mechanical strength is adopted on the deep layers of the inner wall 2A of the straight cylindrical pipe body 2 of the pipeline, and a micro-crystallized glass lining layer mainly consisting of amorphous glass lining capable of resisting corrosion and forming smooth surfaces is adopted on the surface layers of the inner wall 2A of the straight cylindrical pipe body 2 of the pipeline; and micro-crystallized glass lining layers 1a2 mainly consisting of microcrystalline glass lining capable of greatly reinforcing mechanical strength are adopted on the faces of the large flanges 2B at the two ends of the pipeline, so as to avoid the situation that the glass lining layers on the faces of the large flanges are cracked due to great force for tightening bolts, comprehensively improve and guarantee the durability, anticorrosion, wear resistance, smooth circulation and safety operation of the large micro-crystallized glass-lined oil and gas pipelines of the entire line and innovatively manufacture the large micro-crystallized glass-lined pipeline mainly consisting of microcrystalline glass lining.

A manufacturing method of a large micro-crystallized glass-lined pipeline specifically comprises the following steps:

1) manufacturing pipeline components: respectively manufacturing a straight cylindrical pipe body 2 and large flanges 2B formed by flanging two ends of the straight cylindrical pipe body;

steel pipes between iron blanks of the pipeline are welded through girth welding joints, X-ray flaw detection is performed to the girth welding joints according to JB/T4730 to obtain pipe components which are in compliance with supervision regulations on safety technology of pressure vessels, and thickness of steel plates of the pipeline components is in compliance with pipeline pressure vessel design and manufacturing standards;

2) manufacturing an integral pipeline structure: welding reinforcing circular ring bodies 2a on inner sides of the large flanges, the reinforcing circular ring bodies 2a being in close fit with a circumference of an outer side of the straight cylindrical pipe body 2, circumferentially welding a group of girth welding joints between the reinforcing circular ring bodies 2a and the circumference of the outer side of the straight cylindrical pipe body 2, circumferentially welding a group of girth welding joints between the reinforcing circular ring bodies 2a and the large flanges 2B, and assembling to form pipeline components in an integral structure;

the reinforcing circular ring bodies are used for guaranteeing that the faces of the large flanges are not deformed during repetitive high-temperature sintering, and the thickness of steel plates thereof can be set, adjusted and increased according to the magnitude of the nominal diameter of the pipeline;

3) manufacturing reinforcing rebar plates: welding a plurality of groups of symmetrically distributed reinforcing rebar plates 2b on the circumference of the outer side of the straight cylindrical pipe body 2, the reinforcing rebar plates 2b being also welded with the reinforcing circular ring bodies 2a;

the number of the reinforcing rebar plates is 9-21 groups and is selected according to the size of the diameter of the pipeline; and the reinforcing circular ring bodies are combined with 9-21 groups of symmetrical reinforcing rebar plates such that the nominal pressure of the large flanges of the pipeline and the sealing performance of the mouth of the pipeline can be perfectly improved;

4) manufacturing reinforcing steel circular pipe fittings: welding a plurality of groups of symmetrically distributed reinforcing steel circular pipe fittings 2c, which are arranged between the two groups of reinforcing rebar plates 2b, on the circumference of the outer side of the straight cylindrical pipe body 2, two ends of the reinforcing steel circular pipe fittings 2c being respectively welded with an outer wall 2C of the straight cylindrical pipe body and the reinforcing circular ring bodies 2a;

the number of the reinforcing steel circular pipe fittings is 3-6; and the reinforcing steel circular pipe fittings greatly improve the deformation-resistant strength of the integral pipeline;

5) coating glass lining prime coat on the inner wall 2A and the outer wall 2C of the straight cylindrical pipe body 2, the faces of the large flanges 2B, the reinforcing circular ring bodies 2a, the reinforcing rebar plates 2b and the reinforcing steel circular pipe fittings 2c (combinations of the reinforcing circular ring bodies, the reinforcing rebar plates and the reinforcing steel circular pipe fittings can be called as integral outer structural assemblies 2C1);

6) coating micro-crystallized glass lining finish coat on the inner wall 2A and the outer wall 2C of the straight cylindrical pipe body 2, the faces of the large flanges 2B, the reinforcing circular ring bodies 2a, the reinforcing rebar plates 2b and the reinforcing steel circular pipe fittings 2c;

combinations of the micro-crystallized glass lining finish coat are glass lining slurry obtained by mixing and grinding microcrystalline and amorphous glass lining in different formulas and proportions according to demands of all highest technical quality indexes corresponding to specific physiochemical performance of each oil and gas pipeline project;

7) adopting an openable and closeable extra-long horizontal electric heating furnace combined with an intelligent temperature program control/adjustment/recording instrument device to implement a heating-while-rotating sintering process in a combined manner to sinter the pipeline coated with the glass lining, controlling heating temperature between the glass lining prime coat and the micro-crystallized glass lining finish coat and between the micro-crystallized glass lining finish coat and the micro-crystallized glass lining finish coat to be consistent, and performing synchronous integral sintering;

a newly and innovatively developed openable and closeable extra-long horizontal electric heating furnace with an intelligent temperature program control/adjustment/recording instrument device is adopted to implement a controlled sintering “core technique” to the dried glass lining layers coated on the whole body of the pipeline, so as to form optimum and firmest wire-mesh-shaped adherence layers between steel plates and glass lining prime coat, lay a foundation for precisely implementing synchronous integral sintering between the glass lining prime coat and the micro-crystallized glass lining finish coat and between the micro-crystallized glass lining finish coat and the micro-crystallized glass lining finish coat at the same heating temperature, thoroughly eliminate various potential hazards and defects to the utmost extent and realize the highest quality index of zero pinhole;

8) repetitively sintering the pipeline by adopting the sintering method in step 7), and coating glass lining on the pipeline before sintering at each time;

preferably, the glass lining slurry can be uniformly coated by adopting a full-automatic slurry coating apparatus;

the glass lining layers of the large micro-crystallized glass-lined pipeline are repetitively sintered by adopting the newly and innovatively developed openable and closeable extra-long horizontal electric heating furnace combined with the intelligent temperature program control/adjustment/recording instrument device, and the glass lining layers need to be firstly coated to the whole body of the pipeline and then be dried before sintering at each time;

9) cooling the pipeline sintered at the last time together with the furnace according to a specific temperature lowering curve.

A controlled sintering “core technique” is adopted for sintering. A sintering process of medium-temperature pre-sintering, high-temperature sintering, heat preserving and stage-by-stage controlled sintering can be adopted during sintering of the glass lining prime coat on the inner wall of the pipeline, sintering temperature is room temperature to 950° C. and total sintering time is 5.5-6 h.

Specifically, temperature is slowly increased from room temperature to 150° C., then temperature is increased from 150° C. to 400° C. to perform pre-sintering, heat is preserved, then temperature is increased from 400° C. to 600° C. to perform pre-sintering, heat is preserved, total sintering time at a temperature section of room temperature to 600° C. is 4 h, then high-temperature sintering is performed from 600° C. to 950° C., heat is preserved, and total time of high-temperature sintering from 600° C. to 900° C. and heat preservation is 1.5-2 h.

Under normal circumstances, the number of times of repetitive sintering of the large micro-crystallized glass-lined pipeline can reach 6-7.

Further, in step 5), the controlled sintering “core technique” is executed after coating the glass lining prime coat on the inner wall 2A and the outer wall 2C of the straight cylindrical pipe body 2, the faces of the large flanges 2B, the reinforcing circular ring bodies 2a, the reinforcing rebar plates 2b and the reinforcing steel circular pipe fittings 2c, medium-temperature pre-sintering, heat preserving and high-temperature sintering can be precisely controlled, and formation of firm wire-mesh-shaped adherence layers between the outer walls of steel materials and the glass lining prime coat is promoted.

By using the excellent physiochemical performance of the glass lining in combination with the advantage of above-level-8 Mohs hardness of the microcrystalline glass lining, formulas and mixing proportions of microcrystalline and amorphous glass lining can be adopted and adjusted according to each oil and gas pipeline project line and especially demands of specific physiochemical performance such as acid resistance, alkali resistance, wear resistance and seismic and mechanical strength reinforcement of different structural parts of the same pipeline, so as to specially formulate the first highest technical quality index for the oil and gas pipeline project of the entire line to comprehensively improve, reinforce and guarantee smooth circulation, durability, anticorrosion and safety operation.

Micro-crystallized glass lining layers 1a1 mainly consisting of microcrystalline glass lining capable of reinforcing mechanical strength are coated and sintered on several first deep layers of the inner wall 2A of the straight cylindrical pipe body 2, and micro-crystallized glass lining layers 1a1 mainly consisting of amorphous glass lining capable of forming smooth surfaces and resisting corrosion are coated and sintered on several last surface layers.

Micro-crystallized glass lining layers 1a3 mainly consisting anticorrosive and high-seismic-strength microcrystalline glass lining are coated and sintered on the outer wall 2C of the pipeline, the reinforcing circular ring bodies 2a, the reinforcing rebar plates 2b and the reinforcing steel circular pipe fittings 2c.

Micro-crystallized glass lining layers 1a2 mainly consisting of microcrystalline glass lining capable of greatly reinforcing mechanical strength are coated and sintered on the faces of the large flanges 2B at the two ends of the pipeline.

The micro-crystallized glass lining layers 1a1, 1a2, 1a3 are collectively called as micro-crystallized glass lining layers 1a.

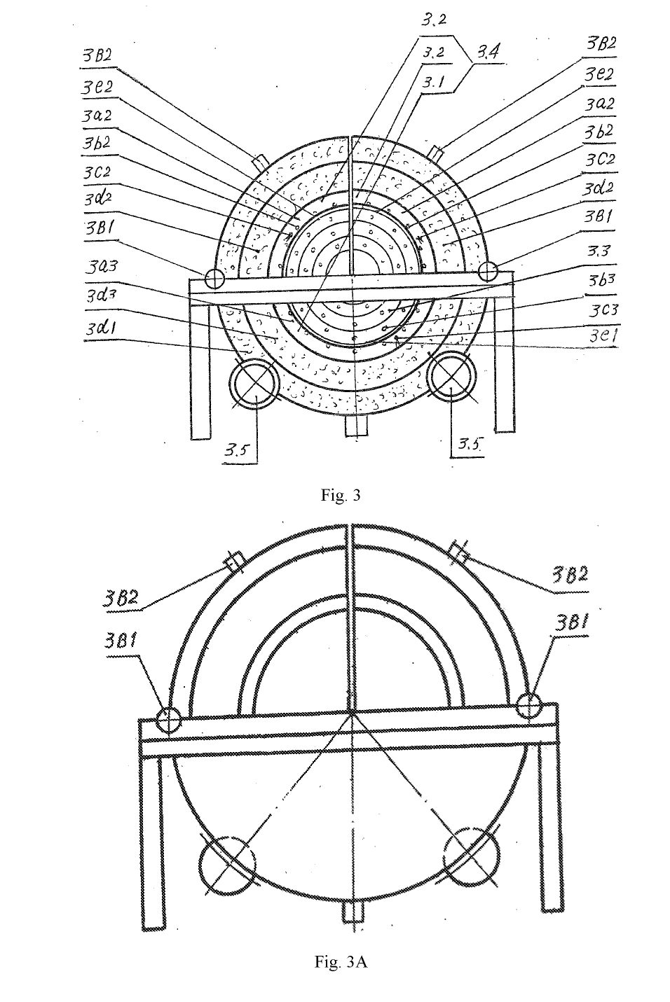

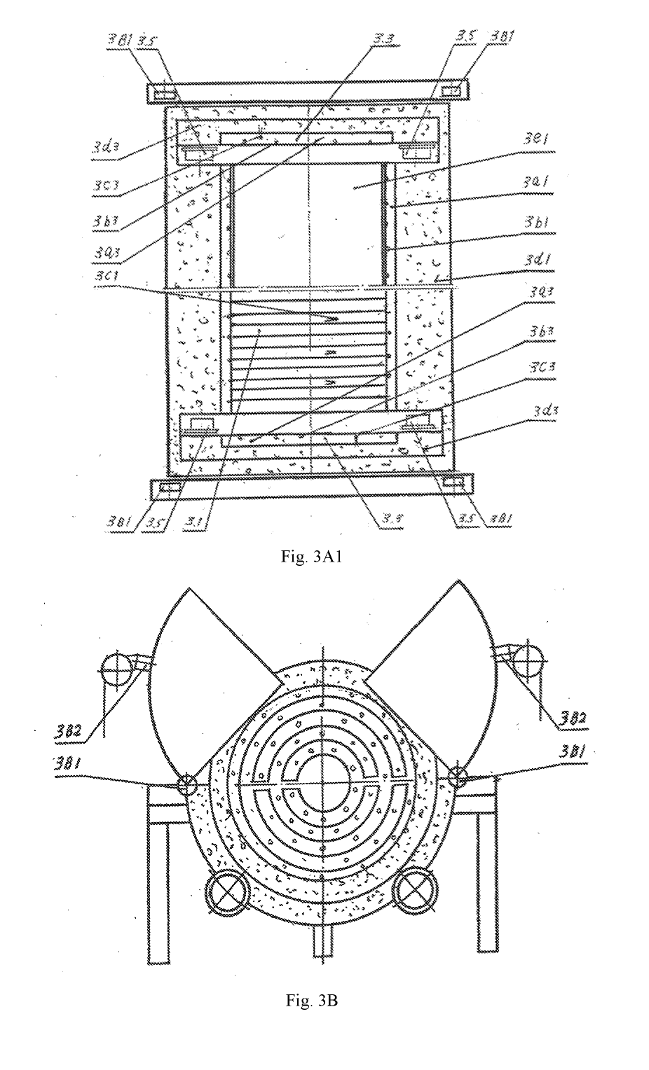

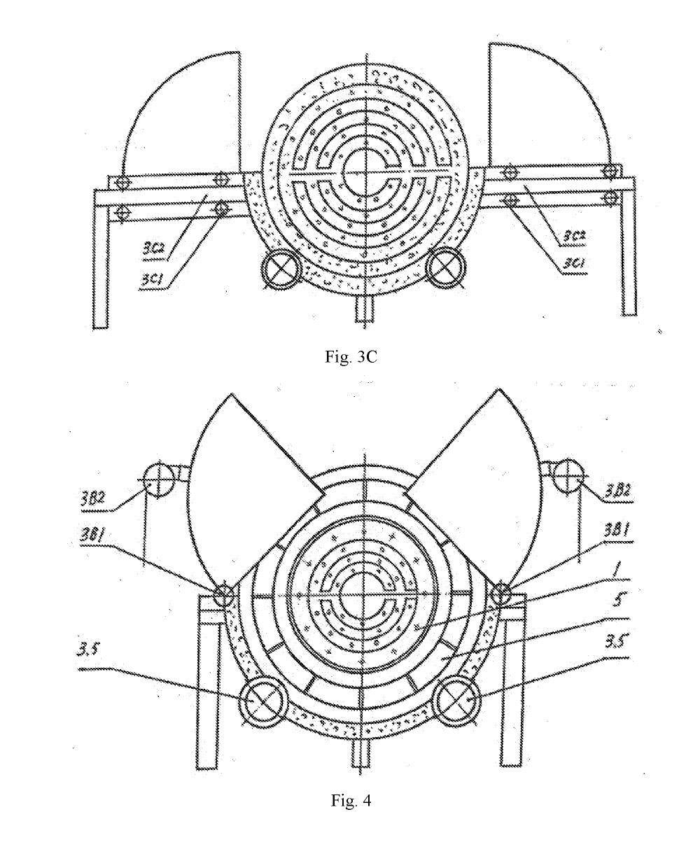

Specifically, as shown in FIG. 3, FIG. 3A and FIG. 3A1, in step 7), the openable and closeable extra-long horizontal electric heating furnace is combined with an intelligent temperature program control/adjustment/recording instrument device, and the openable and closeable extra-long horizontal electric heating furnace comprises a group of fixed horizontal bottom electric heating furnace 3.1 in a shape of a semicircular ring body, two groups of openable and closeable horizontal electric heating furnaces 3.2 in a shape of a ¼ circular ring body and two groups of circular plane electric heating furnaces 3.3; the two groups of openable and closeable horizontal electric heating furnaces 3.2 in the shape of the ¼ circular ring body are arranged at an upper portion of the fixed horizontal bottom electric heating furnace 3.1 in the shape of the semicircular ring body, and in a closed state, the two groups of openable and closeable horizontal electric heating furnaces 3.2 in the shape of the ¼ circular ring body and the fixed horizontal bottom electric heating furnace 3.1 in the shape of the semicircular ring body form a circular ring body; and the two groups of circular plane electric heating furnaces 3.3 are arranged at two ends of the internal portion of the fixed horizontal bottom electric heating furnace 3.1 in the shape of the semicircular ring body and the two groups of openable and closeable horizontal electric heating furnaces 3.2 in the shape of the ¼ circular ring body.

The fixed horizontal bottom electric heating furnace 3.1 in the shape of the semicircular ring body, the two groups of openable and closeable horizontal electric heating furnaces 3.2 in the shape of the ¼ circular ring body and the two groups of circular plane electric heating furnaces 3.3 comprise refractory material layers 3a1, 3a2, 3a3, heat preserving material layers 3d1, 3d2, 3d3 and coaxial arc-shaped heat conducting plates 3e1, 3e2 from inside to outside. The refractory material layers 3a1, 3a2, 3a3 are collectively called as refractory material layers 3a, the heat preserving material layers 3d1, 3d2, 3d3 are collectively called as heat preserving material layers 3d, and the coaxial arc-shaped heat conducting plates 3e1, 3e2 are collectively called as coaxial arc-shaped heat conducting plates 3e.

The two groups of openable and closeable horizontal electric heating furnaces in the shape of the ¼ circular ring body are any one selected from the following openable and closeable mechanical structural devices:

openable and closeable mechanical structural devices of type one:

as shown in FIG. 3B, bottoms of two ends of steel shells of the two groups of openable and closeable horizontal electric heating furnaces 3.2 in the shape of the ¼ circular ring body being provided with more than four groups of rotatable connecting parts 3B1, and circular ring bodies of the steel shells of the two groups of openable and closeable horizontal electric heating furnaces 3.2 in the shape of the ¼ circular ring body being provided with more than four groups of opening and closing parts 3B2 to execute the opening and closing of the two groups of openable and closeable horizontal electric heating furnaces 3.2 in the shape of the ¼ circular ring body; and

openable and closeable mechanical structural devices of type two:

as shown in FIG. 3C, horizontal bottoms of steel shells of the two groups of openable and closeable horizontal electric heating furnaces 3.2 in the shape of the ¼ circular ring body being provided with sliding parts 3C1, and two sides of the two groups of openable and closeable horizontal electric heating furnaces 3.2 in the shape of the ¼ circular ring body being provided with horizontal sliding rails 3C2 allowing the sliding parts 3C1 to horizontally slide. The two groups of openable and closeable horizontal electric heating furnaces in the shape of the ¼ circular ring body can be provided with 16 sliding parts.

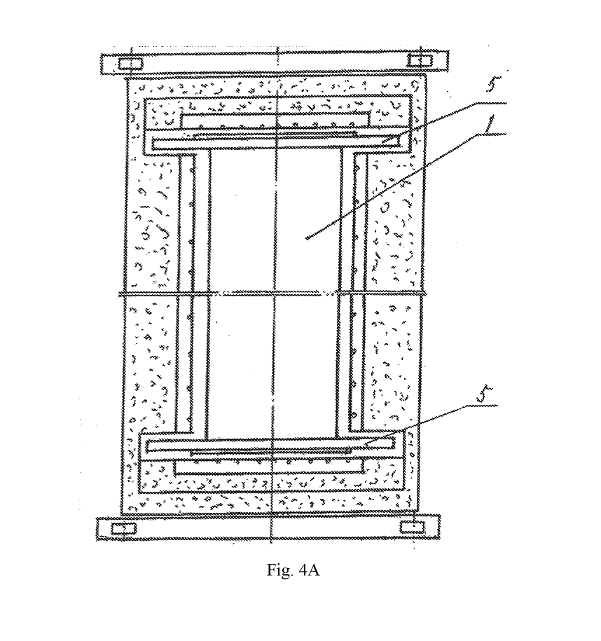

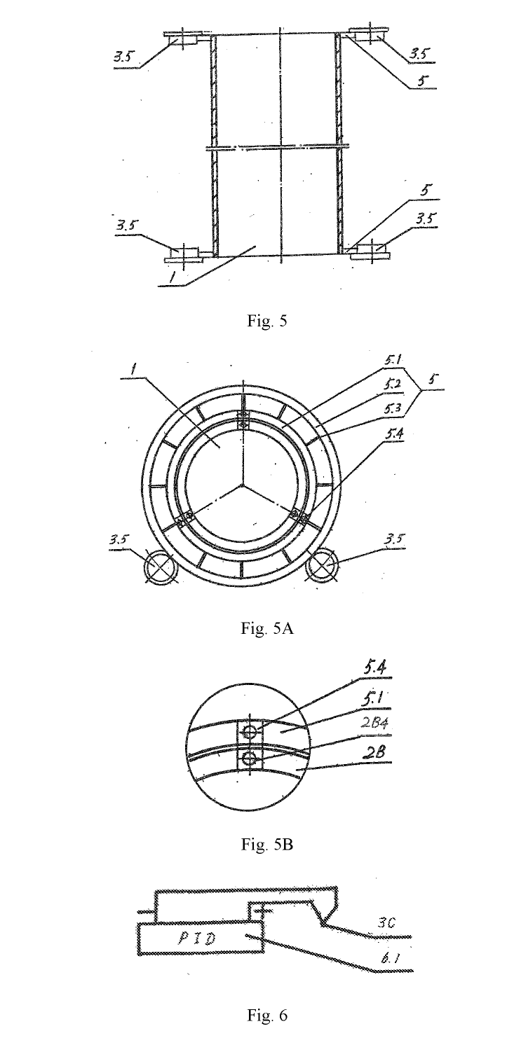

As shown in FIG. 4, FIG. 4A, FIG. 5 and FIG. 5A, the openable and closeable extra-long horizontal electric heating furnace further comprises two groups of pipeline positioning pieces 5, the two groups of pipeline positioning pieces 5 are arranged between the circular plane electric heating furnaces 3.3 and the fixed horizontal bottom electric heating furnace 3.1 in the shape of the semicircular ring body, the pipeline positioning piece 5 comprises an inner circular ring 5.1, an outer circular ring 5.2 and a plurality of groups of symmetrical circular rebars 5.3, the inner circular ring 5.1 and the outer circular ring 5.2 are two groups of concentric all-steel circular rings with different diameters, and the plurality of groups of symmetrical circular rebars 5.3 are arranged between the inner circular ring 5.1 and the outer circular ring 5.2 and are symmetrically distributed along the circumference. A space formed by the inner circular rings 5.1, the outer circular rings 5.2 and the plurality of symmetrical circular rebars 5.3 of the pipeline positioning pieces can be used for operations of lifting the pipeline into and out of the furnace through big traveling cranes. The inner circular rings 5.1 are matched and connected with the pipeline.

As shown in FIG. 4, FIG. 5A and FIG. 5B, the inner diameter of the inner circular rings 5.1 of the pipeline positioning pieces is matched with the outer diameter of the large flanges 2B of the pipeline, the inner circular rings 5.1 of the pipeline positioning pieces and the faces of the large flanges 2B of the pipeline are respectively provided with three bolt holes 2B4 at an interval of 120° and are detachably and tightly connected through three connecting steel plates 5.4 by means of the bolt holes.

The openable and closeable extra-long horizontal electric heating furnace further comprises four rotatable fixed pulleys 3.5 and the four rotatable fixed pulleys 3.5 are arranged on two sides of the outer circular rings 5.2 of the two groups of pipeline positioning pieces 5. The four rotatable fixed pulleys 3.5 are used for implementing a new heating-while-rotating sintering process during sintering of the glass lining layers of the pipeline.

As shown in FIG. 3, chamber walls of integral inner chambers of the fixed horizontal bottom electric heating furnace 3.1 in the shape of the semicircular ring body and the two groups of openable and closeable horizontal electric heating furnaces 3.2 in the shape of the ¼ circular ring body are provided with coaxial arc-shaped heat conducting plates 3e1, 3e2 which are made of heat-resistant steel. The coaxial arc-shaped heat conducting plates 3e1, 3e2 cover the surface layer of the openable and closeable extra-long horizontal electric heating furnace to perfectly improve the heating uniformity of the openable and closeable extra-long horizontal electric heating furnace.

Corresponding micro-crystallized glass lining with different compositions and different sintering temperature can be adopted and adjusted according to specific demands of physiochemical performance and high-standard technical quality of different structural parts of the same pipeline, an integral circular ring body horizontal electric heating furnace 3.4 formed by the fixed horizontal bottom electric heating furnace 3.1 in the shape of the semicircular ring body and the two groups of openable and closeable horizontal electric heating furnaces 3.2 in the shape of the ¼ circular ring body corresponds to the sintering of the micro-crystallized glass lining layers on the inner wall and outer wall of the straight cylindrical pipe body of the pipeline and integral outer structural assemblies, and the two groups of circular plane electric heating furnaces 3.3 correspond to the sintering of the micro-crystallized glass lining layers on the faces of the large flanges at the two ends of the pipeline. Two major temperature control systems respectively formed by the integral circular ring body horizontal electric heating furnace and the two groups of circular plane electric heating furnaces can respectively and effectively adjust different sintering temperature of micro-crystallized glass lining layers with different compositions of different structural parts of the pipeline and the same sintering temperature of micro-crystallized glass lining layers with the same compositions of the same structural part, so as to precisely implement synchronous integral sintering of integral micro-crystallized glass lining layers of the same pipeline and manufacture an extra-large and extra-long large micro-crystallized glass-lined pipeline which is high in quality and safe in operation. The integral outer structural assemblies refer to pipeline components arranged outside the straight cylindrical pipe body, e.g., the reinforcing circular ring bodies, the reinforcing rebar plates and the reinforcing steel circular pipe fittings.

As shown in FIG. 3, FIG. 3a and FIG. 6, a half circumferential wall of an inner side of the fixed horizontal bottom electric heating furnace 3.1 in the shape of the semicircular ring body is provided with a plurality of ½ ring grooves; an electric heating ribbon 3b1 is wound in the ½ ring grooves; ¼ circumferential walls of inner sides of the openable and closeable horizontal electric heating furnaces 3.2 in the shape of the ¼ circular ring body are provided with a plurality of ¼ ring grooves; electric heating ribbons 3b2 are wound in the ¼ ring grooves; the electric heating ribbon 3b1 wound in the ½ ring grooves and the electric heating ribbons 3b2 wound in the two ¼ ring grooves are circumferentially connected to form a group of electric heating ribbons, and the integral circular ring body horizontal electric heating furnace 3.4 consists of a plurality of groups of electric heating ribbons; circular planes of the circular plane electric heating furnaces 3.3 are provided with a plurality of turns of concentric circular grooves with different diameters; a group of electric heating ribbons 3b3 are wound in the concentric circular grooves; each electric heating ribbon is connected with a temperature control system respectively, and the temperature control system comprises a group of thermocouples 3c1, 3c2, 3c3 and an intelligent temperature program control/adjustment/recording instrument device 6.1. Two major temperature control systems formed by the integral circular ring body horizontal electric heating furnace 3.4 and the two groups of circular plane electric heating furnaces 3.3 can respectively adjust heating power, and precisely implement synchronous integral sintering of different micro-crystallized glass lining layers of different structural parts of the pipeline at different sintering temperature, the micro-crystallized glass lining layers with the same compositions of the same structural part at the same sintering temperature and the integral micro-crystallized glass lining layers of the same pipeline. The electric heating ribbons 3b1, 3b2, 3b3 are collectively called as electric heating ribbons 3b, and the thermocouples 3c1, 3c2, 3c3 are collectively called as thermocouples 3c.

The group of thermocouples 3c1, 3c2, 3c3 are matched with a group of electric heating ribbons 3b1, 3b2, 3b3, are arranged in a heating area of the group of electric heating ribbons and are used for detecting the heating temperature of the micro-crystallized glass lining layers of the pipeline in the heating area of the electric heating ribbons and sending out temperature signals; and the intelligent temperature program control/adjustment/recording instrument device 6.1 is arranged outside the openable and closeable extra-long horizontal electric heating furnace, is connected with the group of electric heating ribbons matched with the group of thermocouples and executes automatic printing, recording, filing and quality tracking during sintering. The intelligent temperature program control/adjustment/recording device stores a preset temperature or temperature control curve therein, and is used for receiving temperature signals of the thermocouples and adjusting the heating temperature of the electric heating ribbons after comparison with the preset temperature or temperature control curve.

Openable and closeable extra-long horizontal electric heating furnaces with length of 26 m and diameter of 1.8 m are manufactured and large micro-crystallized glass-lined pipelines with length of 25 m and diameter of 1 m are developed and produced respectively according to the above-mentioned methods. As detected according to detection methods in GB25025-2010 Technical Conditions for Glass-lined Equipment, the seismic and mechanical strength is greatly reinforced, the large flanges are not deformed and the number of pinholes in the glass lining layers is zero, such that the overall quality, the service life and the safety operation of the large micro-crystallized glass-lined pipelines are greatly improved.

The above-mentioned embodiments are just used for exemplarily describing the principle and effects of the present invention instead of limiting the present invention. Any one skilled in the art can make modifications or variations to the above-mentioned embodiments without departing from the spirit and range of the present invention. Therefore, all equivalent modifications or variations made by those who have common knowledge in the art without departing from the spirit and technical concept disclosed by the present invention shall still be covered by the claims of the present invention.

1. A large micro-crystallized glass-lined pipeline, comprising a straight cylindrical pipe body and wherein the large micro-crystallized glass-lined pipeline further comprises large flanges and reinforcing circular ring bodies, two ends of the straight cylindrical pipe body are flanged to form the large flanges, the reinforcing circular ring bodies are in close fit with a circumference of an outer side of the straight cylindrical pipe body and are welded on inner sides of the large flanges, and micro-crystallized glass lining layers are coated and sintered on an inner wall and an outer wall of the straight cylindrical pipe body, outer sides of the large flanges and outer sides of the reinforcing circular ring bodies.

2. The large micro-crystallized glass-lined pipeline according to claim 1, wherein circumferentially welded girth welding joints are formed between the reinforcing circular ring bodies and the circumference of the outer side of the straight cylindrical pipe body, and circumferentially welded girth welding joints are formed between the reinforcing circular ring bodies and the large flanges.

3. The large micro-crystallized glass-lined pipeline according to claim 1, wherein the large micro-crystallized glass-lined pipeline further comprises reinforcing rebar plates, the reinforcing rebar plates are symmetrically distributed along the circumference of the outer side of the straight cylindrical pipe body, the reinforcing rebar plates are welded on the circumference of the outer side of the straight cylindrical pipe body and are welded with the reinforcing circular ring bodies, and micro-crystallized glass lining layers are coated and sintered on outer sides of the reinforcing rebar plates.

4. The large micro-crystallized glass-lined pipeline according to claim 3, wherein the large micro-crystallized glass-lined pipeline further comprises reinforcing steel circular pipe fittings, the reinforcing steel circular pipe fittings are symmetrically distributed along the circumference of the outer side of the straight cylindrical pipe body and are arranged between two groups of reinforcing rebar plates, two ends of the reinforcing steel circular pipe fittings are respectively welded with the outer wall of the straight cylindrical pipe body and the reinforcing circular ring bodies, and micro-crystallized glass lining layers are coated and sintered on outer sides of the reinforcing steel circular pipe fittings.

5. The large micro-crystallized glass-lined pipeline according to claim 1, wherein the micro-crystallized glass lining layers of the large micro-crystallized glass-lined pipeline are prepared by adopting a manufacturing method through an openable and closeable extra-long horizontal electric heating furnace combined with an intelligent temperature program control/adjustment/recording instrument device, the intelligent temperature program control/adjustment/recording instrument device has temperature control accuracy of ±1° C. and is combined with the openable and closeable extra-long horizontal electric heating furnace, and a heating-while-rotating sintering process is implemented in a combined manner.

6. The large micro-crystallized glass-lined pipeline according to claim 5, wherein the openable and closeable extra-long horizontal electric heating furnace comprises a group of fixed horizontal bottom electric heating furnace in a shape of a semicircular ring body, two groups of openable and closeable horizontal electric heating furnaces in a shape of a ¼ circular ring body and two groups of circular plane electric heating furnaces; the two groups of openable and closeable horizontal electric heating furnaces in the shape of the ¼ circular ring body are arranged at an upper portion of the fixed horizontal bottom electric heating furnace in the shape of the semicircular ring body, and in a closed state, the two groups of openable and closeable horizontal electric heating furnaces in the shape of the ¼ circular ring body and the fixed horizontal bottom electric heating furnace in the shape of the semicircular ring body form a circular ring body; and the two groups of circular plane electric heating furnaces are arranged at two ends of the fixed horizontal bottom electric heating furnace in the shape of the semicircular ring body and the two groups of openable and closeable horizontal electric heating furnaces in the shape of the ¼ circular ring body.

7. The large micro-crystallized glass-lined pipeline according to claim 6, wherein an integral circular ring body horizontal electric heating furnace formed by the fixed horizontal bottom electric heating furnace in the shape of the semicircular ring body and the two groups of openable and closeable horizontal electric heating furnaces in the shape of the ¼ circular ring body corresponds to sintering of the micro-crystallized glass lining layers on the inner wall and the outer wall of the straight cylindrical pipe body and integral outer structural assemblies of the large micro-crystallized glass-lined pipeline, and the two groups of circular plane electric heating furnaces correspond to sintering of the micro-crystallized glass lining layers on the faces of the large flanges at the two ends of the pipeline.

8. The large micro-crystallized glass-lined pipeline according to claim 7, wherein the micro-crystallized glass lining layer on the inner wall of the straight cylindrical pipe body, the micro-crystallized glass lining layers on the outer wall of the straight cylindrical pipe body and the integral outer structural assemblies and the micro-crystallized glass lining layers on the faces of the large flanges at the two ends of the pipeline are different in compositions.

9. The large micro-crystallized glass-lined pipeline according to claim 8, wherein the micro-crystallized glass lining layers consisting of microcrystalline and amorphous glass lining in different adjustable formulas and proportions are adopted according to specific demands of different physiochemical performance of different structural parts of the same pipeline; a micro-crystallized glass lining layer mainly consisting of microcrystalline glass lining capable of reinforcing mechanical strength is adopted on the deep layers of the inner wall of the straight cylindrical pipe body of the pipeline, and a micro-crystallized glass lining layer mainly consisting of amorphous glass lining capable of resisting corrosion and forming smooth surfaces is adopted on the surface layers of the inner wall of the straight cylindrical pipe body of the pipeline; and micro-crystallized glass lining layers mainly consisting of microcrystalline glass lining capable of greatly reinforcing mechanical strength are adopted on the faces of the large flanges at the two ends of the pipeline, so as to innovatively manufacture the large micro-crystallized glass-lined pipeline mainly consisting of microcrystalline glass lining.

10. A manufacturing method of the large micro-crystallized glass-lined pipeline according to claim 1, specifically comprising the following steps:
1) manufacturing pipeline components: respectively manufacturing a straight cylindrical pipe body and large flanges formed by flanging two ends of the straight cylindrical pipe body;
2) manufacturing an integral pipeline structure: welding reinforcing circular ring bodies on inner sides of the large flanges, the reinforcing circular ring bodies being in close fit with a circumference of an outer side of the straight cylindrical pipe body, circumferentially welding a group of girth welding joints between the reinforcing circular ring bodies and the circumference of the outer side of the straight cylindrical pipe body, circumferentially welding a group of girth welding joints between the reinforcing circular ring bodies and the large flanges, and assembling to form pipeline components in an integral structure;
3) manufacturing reinforcing rebar plates: welding a plurality of groups of symmetrically distributed reinforcing rebar plates on the circumference of the outer side of the straight cylindrical pipe body, the reinforcing rebar plates being welded with the reinforcing circular ring bodies;
4) manufacturing reinforcing steel circular pipe fittings: welding a plurality of groups of symmetrically distributed reinforcing steel circular pipe fittings, which are arranged between the two groups of reinforcing rebar plates, on the circumference of the outer side of the straight cylindrical pipe body, two ends of the reinforcing steel circular pipe fittings being respectively welded with an outer wall of the straight cylindrical pipe body and the reinforcing circular ring bodies;
5) coating glass lining prime coat on the inner wall and the outer wall of the straight cylindrical pipe body, the faces of the large flanges, the reinforcing circular ring bodies, the reinforcing rebar plates and the reinforcing steel circular pipe fittings;
6) coating micro-crystallized glass lining finish coat on the inner wall and the outer wall of the straight cylindrical pipe body, the faces of the large flanges, the reinforcing circular ring bodies, the reinforcing rebar plates and the reinforcing steel circular pipe fittings;
7) adopting an openable and closeable extra-long horizontal electric heating furnace combined with an intelligent temperature program control/adjustment/recording instrument device to implement a heating-while-rotating sintering process in a combined manner to sinter the pipeline coated with the glass lining, controlling heating temperature between the glass lining prime coat and the micro-crystallized glass lining finish coat and between the micro-crystallized glass lining finish coat and the micro-crystallized glass lining finish coat to be consistent, and performing synchronous integral sintering;
8) repetitively sintering the pipeline by adopting the sintering method in step 7), and coating glass lining on the pipeline before sintering at each time; and
9) cooling the pipeline sintered at the last time together with the furnace according to a specific temperature lowering curve.

11. The manufacturing method of the large micro-crystallized glass-lined pipeline according to claim 10, wherein, in step 5), a controlled sintering “core technique” is executed after coating the glass lining prime coat on the inner wall and the outer wall of the straight cylindrical pipe body, the faces of the large flanges, the reinforcing circular ring bodies, the reinforcing rebar plates and the reinforcing steel circular pipe fittings medium-temperature pre-sintering, heat preserving and high-temperature sintering can be precisely controlled, and formation of firm wire-mesh-shaped adherence layers between the outer walls of steel materials and the glass lining prime coat is promoted.

12. The manufacturing method of the large micro-crystallized glass-lined pipeline according to claim 10, wherein, in step 7), the openable and closeable extra-long horizontal electric heating furnace is combined with an intelligent temperature program control/adjustment/recording instrument device, and the openable and closeable extra-long horizontal electric heating furnace comprises a group of fixed horizontal bottom electric heating furnace in a shape of a semicircular ring body, two groups of openable and closeable horizontal electric heating furnaces in a shape of a ¼ circular ring body and two groups of circular plane electric heating furnaces; the two groups of openable and closeable horizontal electric heating furnaces in the shape of the ¼ circular ring body are arranged at an upper portion of the fixed horizontal bottom electric heating furnace in the shape of the semicircular ring body, and in a closed state, the two groups of openable and closeable horizontal electric heating furnaces in the shape of the ¼ circular ring body and the fixed horizontal bottom electric heating furnace in the shape of the semicircular ring body form a circular ring body; and the two groups of circular plane electric heating furnaces are arranged at two ends of the fixed horizontal bottom electric heating furnace in the shape of the semicircular ring body and the two groups of openable and closeable horizontal electric heating furnaces in the shape of the ¼ circular ring body.

13. The manufacturing method of the large micro-crystallized glass-lined pipeline according to claim 12, wherein the two groups of openable and closeable horizontal electric heating furnaces in the shape of the ¼ circular ring body are any one selected from the following openable and closeable mechanical structural devices:
openable and closeable mechanical structural devices of type one:
bottoms of two ends of steel shells of the two groups of openable and closeable horizontal electric heating furnaces in the shape of the ¼ circular ring body being provided with more than four groups of rotatable connecting parts, and circular ring bodies of the steel shells of the two groups of openable and closeable horizontal electric heating furnaces in the shape of the ¼ circular ring body being provided with more than four groups of opening and closing parts; and
openable and closeable mechanical structural devices of type two:
horizontal bottoms of steel shells of the two groups of openable and closeable horizontal electric heating furnaces in the shape of the ¼ circular ring body being provided with sliding parts, and two sides of the two groups of openable and closeable horizontal electric heating furnaces in the shape of the ¼ circular ring body being provided with horizontal sliding rails allowing the sliding parts to horizontally slide.

14. The manufacturing method of the large micro-crystallized glass-lined pipeline according to claim 12, wherein the openable and closeable extra-long horizontal electric heating furnace further comprises two groups of pipeline positioning pieces, the pipeline positioning pieces are arranged between the circular plane electric heating furnaces and the fixed horizontal bottom electric heating furnace in the shape of the semicircular ring body, each pipeline positioning piece comprises an inner circular ring, an outer circular ring and a plurality of groups of symmetrical circular rebars, the inner circular ring and the outer circular ring are two groups of concentric all-steel circular rings with different diameters, and the plurality of groups of symmetrical circular rebars are arranged between the inner circular ring and the outer circular ring and are symmetrically distributed along the circumference.

15. The manufacturing method of the large micro-crystallized glass-lined pipeline according to claim 14, wherein the openable and closeable extra-long horizontal electric heating furnace further comprises four rotatable fixed pulleys and the four rotatable fixed pulleys are arranged on two sides of the outer circular rings of the two groups of pipeline positioning pieces.

16. The manufacturing method of the large micro-crystallized glass-lined pipeline according to claim 15, wherein the two groups of circular plane electric heating furnaces correspond to sintering of micro-crystallized glass lining layers mainly consisting of microcrystalline glass lining on the faces of the large flanges at the two ends of the pipeline, the four rotatable fixed pulleys driving the two groups of pipeline positioning pieces to rotate are combined with the intelligent temperature program control/adjustment/recording instrument device having temperature control accuracy of ±1° C., requirements of a specific high-standard microcrystalline glass lining sintering process are comprehensively and perfectly satisfied, and an extra-large and extra-long large micro-crystallized glass lining oil and gas pipeline which is excellent in quality and safe in operation is innovatively manufactured.

17. The manufacturing method of the large micro-crystallized glass-lined pipeline according to claim 12, wherein chamber walls of integral inner chambers of the fixed horizontal bottom electric heating furnace in the shape of the semicircular ring body and the two groups of openable and closeable horizontal electric heating furnaces in the shape of the ¼ circular ring body are provided with coaxial arc-shaped heat conducting plates which are made of heat-resistant steel.

18. The manufacturing method of the large micro-crystallized glass-lined pipeline according to claim 12, wherein a half circumferential wall of an inner side of the fixed horizontal bottom electric heating furnace in the shape of the semicircular ring body is provided with a plurality of ½ ring grooves; an electric heating ribbon is wound in the ½ ring grooves; ¼ circumferential walls of inner sides of the openable and closeable horizontal electric heating furnaces in the shape of the ¼ circular ring body are provided with a plurality of ¼ ring grooves; electric heating ribbons are wound in the ¼ ring grooves; the electric heating ribbon wound in the ½ ring grooves and the electric heating ribbons wound in the two ¼ ring grooves are circumferentially connected to form a group of electric heating ribbons, and the integral circular ring body horizontal electric heating furnace consists of a plurality of groups of electric heating ribbons; circular planes of the circular plane electric heating furnaces are provided with a plurality of turns of concentric circular grooves with different diameters; a group of electric heating ribbons are wound in the concentric circular grooves; each electric heating ribbon is connected with a temperature control system respectively, and the temperature control system comprises a group of thermocouples and an intelligent temperature program control/adjustment/recording instrument device.

19. The manufacturing method of the large micro-crystallized glass-lined pipeline according to claim 18, wherein the group of thermocouples are matched with a group of electric heating ribbons and are arranged in a heating area of the group of electric heating ribbon; and the intelligent temperature program control/adjustment/recording instrument device is arranged outside the openable and closeable extra-long horizontal electric heating furnace and is connected with the group of electric heating ribbons matched with the group of thermocouples.

20. The manufacturing method of the large micro-crystallized glass-lined pipeline according to claim 19, wherein the integral circular ring body horizontal electric heating furnace and the two groups of circular plane electric heating furnaces form two major temperature control systems, which are respectively and independently connected with a group of electric heating ribbons and a group of corresponding thermocouples and are respectively combined with the intelligent temperature program control/adjustment/recording devices to respectively and independently adjust heating power, set temperature accuracy to be ±1° C. and precisely implement synchronous integral sintering of the micro-crystallized glass lining layers with different compositions of different structural parts of the pipeline at different sintering temperature and the integral micro-crystallized glass lining layers with different compositions of the same pipeline.

21. A micro-crystallized glass-lined large flange face, wherein a micro-crystallized glass lining layer mainly consisting of microcrystalline glass lining is coated and sintered on the large flange face, and the micro-crystallized glass lining layer is obtained through a preparation method comprising the following steps:
1) coating glass lining prime coat on the large flange face;
2) coating micro-crystallized glass lining finish coat on the large flange face;
3) adopting an openable and closeable extra-long horizontal electric heating furnace combined with an intelligent temperature program control/adjustment/recording instrument device to implement a heating-while-rotating sintering process in a combined manner to sinter the large flange face coated with the glass lining at each time, controlling heating temperature between the glass lining prime coat and the micro-crystallized glass lining finish coat and between the micro-crystallized glass lining finish coat and the micro-crystallized glass lining finish coat to be consistent, and performing synchronous integral sintering;
4) adopting the heating-while-rotating sintering process, precisely selecting optimum rotating speed aiming at a feature that the micro-crystallized glass lining layer easily flows during sintering at the specific highest temperature, and effectively controlling the lining layer on the large flange face to flow uniformly on the whole;
5) repetitively sintering the large flange face by adopting the sintering method in step 4), and coating glass lining on the large flange face before sintering at each time;
6) sintering the large flange face at specific highest temperature at each time to precisely select furnace temperature controlling the micro-crystallized glass lining layer in an initial solidified state not to flow; and
7) cooling the large flange face sintered at the last time together with the furnace according to a specific temperature lowering curve.

22. The micro-crystallized glass-lined large flange face according to claim 21, wherein, in step 3), the openable and closeable extra-long horizontal electric heating furnace comprises a group of fixed horizontal bottom electric heating furnace in a shape of a semicircular ring body, two groups of openable and closeable horizontal electric heating furnaces in a shape of a ¼ circular ring body and two groups of circular plane electric heating furnaces; the two groups of openable and closeable horizontal electric heating furnaces in the shape of the ¼ circular ring body are arranged at an upper portion of the fixed horizontal bottom electric heating furnace in the shape of the semicircular ring body, and in a closed state, the two groups of openable and closeable horizontal electric heating furnaces in the shape of the ¼ circular ring body and the fixed horizontal bottom electric heating furnace in the shape of the semicircular ring body form a circular ring body; the two groups of circular plane electric heating furnaces are arranged at two ends of the fixed horizontal bottom electric heating furnace in the shape of the semicircular ring body and the two groups of openable and closeable horizontal electric heating furnaces in the shape of the ¼ circular ring body, the two groups of circular plane electric heating furnaces in combination with the intelligent temperature program control/adjustment/recording instrument device form a system with temperature control accuracy of ±1° C. and correspond to sintering of micro-crystallized glass lining layers on faces of large flanges at two ends of a pipeline, and comprehensively and perfectly improving extra-high seismic and mechanical strength and sealing performance of the large flange faces of the pipeline is innovatively determined as the first highest quality index of safety operation.

23. The micro-crystallized glass-lined large flange face according to claim 21, wherein the micro-crystallized glass lining layer on the large flange face has extra-high mechanical strength performance and is used for comprehensively opening a new prospect in manufacturing of large flange faces of modern glass-lined reaction tanks.

24. An openable and closeable extra-long horizontal electric heating furnace, wherein the openable and closeable extra-long horizontal electric heating furnace comprises a group of fixed horizontal bottom electric heating furnace in a shape of a semicircular ring body, two groups of openable and closeable horizontal electric heating furnaces in a shape of a ¼ circular ring body and two groups of circular plane electric heating furnaces; the two groups of openable and closeable horizontal electric heating furnaces in the shape of the ¼ circular ring body are arranged at an upper portion of the fixed horizontal bottom electric heating furnace in the shape of the semicircular ring body, and in a closed state, the two groups of openable and closeable horizontal electric heating furnaces in the shape of the ¼ circular ring body and the fixed horizontal bottom electric heating furnace in the shape of the semicircular ring body form a circular ring body; and the two groups of circular plane electric heating furnaces are arranged at two ends of the fixed horizontal bottom electric heating furnace in the shape of the semicircular ring body and the two groups of openable and closeable horizontal electric heating furnaces in the shape of the ¼ circular ring body.

25. The openable and closeable extra-long horizontal electric heating furnace according to claim 24, wherein the fixed horizontal bottom electric heating furnace in the shape of the semicircular ring body, the two groups of openable and closeable horizontal electric heating furnaces in the shape of the ¼ circular ring body and the two groups of circular plane electric heating furnaces comprise refractory material layers and heat preserving material layers from inside to outside.

26. The openable and closeable extra-long horizontal electric heating furnace according to claim 24, wherein the two groups of openable and closeable horizontal electric heating furnaces in the shape of the ¼ circular ring body are any one selected from the following openable and closeable mechanical structural devices:
openable and closeable mechanical structural devices of type one:
bottoms of two ends of steel shells of the two groups of openable and closeable horizontal electric heating furnaces in the shape of the ¼ circular ring body being provided with more than four groups of rotatable connecting parts, and circular ring bodies of the steel shells of the two groups of openable and closeable horizontal electric heating furnaces in the shape of the ¼ circular ring body being provided with more than four groups of opening and closing parts; and
openable and closeable mechanical structural devices of type two:
horizontal bottoms of steel shells of the two groups of openable and closeable horizontal electric heating furnaces in the shape of the ¼ circular ring body being provided with sliding parts, and two sides of the two groups of openable and closeable horizontal electric heating furnaces in the shape of the ¼ circular ring body being provided with horizontal sliding rails allowing the sliding parts to horizontally slide.

27. The openable and closeable extra-long horizontal electric heating furnace according to claim 24, wherein the openable and closeable extra-long horizontal electric heating furnace further comprises two groups of pipeline positioning pieces, the pipeline positioning pieces are arranged between the circular plane electric heating furnaces and the fixed horizontal bottom electric heating furnace in the shape of the semicircular ring body, the pipeline positioning piece comprises an inner circular ring, an outer circular ring and a plurality of groups of symmetrical circular rebars, the inner circular ring and the outer circular ring are two groups of concentric all-steel circular rings with different diameters, and the plurality of groups of symmetrical circular rebars are arranged between the inner circular ring and the outer circular ring and are symmetrically distributed along the circumference.

28. The openable and closeable extra-long horizontal electric heating furnace according to claim 27, wherein the openable and closeable extra-long horizontal electric heating furnace further comprises four rotatable fixed pulleys and the four rotatable fixed pulleys are arranged on two sides of the outer circular rings of the two groups of pipeline positioning pieces.

29. The openable and closeable extra-long horizontal electric heating furnace according to claim 24, wherein chamber walls of integral inner chambers of the fixed horizontal bottom electric heating furnace in the shape of the semicircular ring body and the two groups of openable and closeable horizontal electric heating furnaces in the shape of the ¼ circular ring body are provided with coaxial arc-shaped heat conducting plates which are made of heat-resistant steel.

30. The openable and closeable extra-long horizontal electric heating furnace according to claim 24, wherein a half circumferential wall of an inner side of the fixed horizontal bottom electric heating furnace in the shape of the semicircular ring body is provided with a plurality of ½ ring grooves; an electric heating ribbon is wound in the ½ ring grooves; ¼ circumferential walls of inner sides of the openable and closeable horizontal electric heating furnaces in the shape of the ¼ circular ring body are provided with a plurality of ¼ ring grooves; electric heating ribbons are wound in the ¼ ring grooves; the electric heating ribbon wound in the ½ ring grooves and the electric heating ribbons wound in the two ¼ ring grooves are circumferentially connected to form a group of electric heating ribbons, the fixed horizontal bottom electric heating furnace in the shape of the semicircular ring body and the two groups of openable and closeable horizontal electric heating furnaces in the shape of the ¼ circular ring body form an integral circular ring body horizontal electric heating furnace, and the integral circular ring body horizontal electric heating furnace consists of a plurality of groups of electric heating ribbons; circular planes of the circular plane electric heating furnaces are provided with a plurality of turns of concentric circular grooves with different diameters; a group of electric heating ribbons are wound in the concentric circular grooves; each electric heating ribbon is connected with a temperature control system, and the temperature control system comprises a group of thermocouples and an intelligent temperature program control/adjustment/recording instrument device.

31. The openable and closeable extra-long horizontal electric heating furnace according to claim 30, wherein the group of thermocouples are matched with a group of electric heating ribbons and are arranged in a heating area of the group of electric heating ribbon; and the intelligent temperature program control/adjustment/recording instrument device is arranged outside the openable and closeable extra-long horizontal electric heating furnace and is connected with the group of electric heating ribbons matched with the group of thermocouples.

32. The openable and closeable extra-long horizontal electric heating furnace according to claim 31, wherein the integral circular ring body horizontal electric heating furnace and the two groups of circular plane electric heating furnaces form two major temperature control systems, which are respectively and independently connected with a group of electric heating ribbons and a group of corresponding thermocouples and are respectively combined with the intelligent temperature program control/adjustment/recording devices to respectively and independently adjust heating power, set temperature accuracy to be ±1° C. and precisely implement synchronous integral sintering of the micro-crystallized glass lining layers with different compositions of different structural parts of the pipeline at different sintering temperature and the integral micro-crystallized glass lining layers with different compositions of the same pipeline.
